(19) United States
(12) Patent Application Publication
(10) Pub. No.: US 2025/0020933 A1
(43) Pub. Date: Jan. 16, 2025

(54) OPTICAL SYSTEM AND IMAGE DISPLAY DEVICE

(71) Applicant: Panasonic Intellectual Property Management Co., Ltd., Osaka (JP)

(72) Inventors: Satoshi KUZUHARA, Osaka (JP); Akira HASHIYA, Osaka (JP); Kazuhiro MINAMI, Osaka (JP)

(21) Appl. No.: 18/892,794

(22) Filed: Sep. 23, 2024

Related U.S. Application Data
(63) Continuation of application No. PCT/JP2022/048390, filed on Dec. 27, 2022.

(30) Foreign Application Priority Data
Mar. 31, 2022 (JP) 2022-060592

(51) Int. Cl. G02B 27/01

(52) U.S. Cl. CPC G02B 27/0172; G02B 2027/0123

(57) ABSTRACT

The optical system includes a light guide including a reproduction region including a dividing diffraction structure dividing an image light ray propagating in a first propagation direction intersecting a thickness direction of a body, into image light rays propagating in a second propagation direction intersecting the first propagation direction, in the first propagation direction and including first and second diffraction structure regions formed respectively at first and second surfaces in the thickness direction to face each other, and an exit diffraction structure allowing the image light rays propagating in the second propagation direction to travel toward a field of view region. When first and second field of view angles in first and second directions of the virtual image are denoted by FOV1 and FOV2, a relation of FOV2/FOV1<0.5 is satisfied. The first propagation direction in the reproduction region corresponds to the first direction in a virtual image.

### CROSS-REFERENCE TO RELATED APPLICATIONS

The present application is a continuation of PCT/JP2022/048390 filed Dec. 27, 2022, which claims priority to Japanese Patent Application No. 2022-060592, filed on Mar. 31, 2022, the entire contents of which are incorporated herein by reference.

### TECHNICAL FIELD

The present disclosure relates to optical systems and image display devices.

### BACKGROUND ART

Patent literature 1 discloses an optical element (optical system) including a waveguide (light guide) for exit pupil expansion in two directions. The optical element includes three diffractive optical elements (DOE). The first DOE couples a beam from an imager into the waveguide. The second DOE expands the exit pupil in a first direction along a first coordinate axis. The third DOE expands the exit pupil in a second direction along a second coordinate axis, and couples light out of the waveguide.

### CITATION LIST

### Patent Literature

PATENT LITERATURE 1: U.S. Ser. No. 10/429,645 B2

### SUMMARY OF INVENTION

### Technical Problem

The optical element disclosed in patent literature 1 can be used in a head mounted display, for example. In the head mounted display, there is a need to reduce an area of a field of view region where no pupil of an image light ray forming an image is located, and to improve a usage efficiency of an image light ray.

The present disclosure provides an optical system and an image display device which can reduce an area of a field of view region where no pupil of an image light ray is located and improve a usage efficiency of an image light ray, and further can reduce a manufacture cost.

### Solution to Problem

An optical system according to one aspect of the present disclosure includes a light guide for guiding an image light ray which is output from a display element and forms an image, to a field of view region of a user as a virtual image. The light guide includes: a body having a plate shape and including a first surface and a second surface in a thickness direction; an in-coupling region formed at the body and allowing the image light ray to enter the body so that the image light ray propagates inside the body; and a reproduction region formed at the body and including a dividing diffraction structure dividing an image light ray propagating in a first propagation direction intersecting the thickness direction of the body into a plurality of image light rays propagating in a second propagation direction intersecting the first propagation direction, in the first propagation direction and an exit diffraction structure allowing the plurality of image light rays propagating in the second propagation direction to travel toward the field of view region. The dividing diffraction structure includes a first diffraction structure region and a second diffraction structure region which are formed respectively at the first surface and the second surface to face each other. The virtual image has a first direction and a second direction which are perpendicular to each other. When a first field of view angle in the first direction of the virtual image is denoted by FOV1 and a second field of view angle in the second direction of the virtual image is denoted by FOV2, a relation of FOV2/FOV1<0.5 is satisfied. The first propagation direction in the reproduction region corresponds to the first direction in the virtual image.

An optical system according to one aspect of the present disclosure includes a projection optical system for projecting an image light ray which is output from a display element and forms an image; and a light guide for guiding the image light ray projected by the projection optical system to a field of view region of a user as a virtual image. The light guide includes: a body having a plate shape and including a first surface and a second surface in a thickness direction; an in-coupling region formed at the body and allowing the image light ray to enter the body so that the image light ray propagates inside the body; and a reproduction region formed at the body and including a dividing diffraction structure dividing an image light ray propagating in a first propagation direction intersecting the thickness direction of the body into a plurality of image light rays propagating in a second propagation direction intersecting the first propagation direction, in the first propagation direction and an exit diffraction structure allowing the plurality of image light rays propagating in the second propagation direction to travel toward the field of view region. The dividing diffraction structure includes a first diffraction structure region and a second diffraction structure region which are formed respectively at the first surface and the second surface to face each other. An entrance pupil of the projection optical system has a first direction and a second direction which are perpendicular to each other. A first dimension in the first direction of the entrance pupil is smaller than a second dimension in the second direction of the entrance pupil. The first propagation direction in the reproduction region corresponds to the first direction in the entrance pupil.

An image display device according to an aspect of the present disclosure includes the aforementioned optical system and the display element.

### Advantageous Effects of Invention

Aspects of the present disclosure can reduce an area of a field of view region where no pupil of an image light ray is located and improve a usage efficiency of an image light ray, and further can reduce a manufacture cost.

### BRIEF DESCRIPTION OF DRAWINGS

FIG. 1 is a schematic view of a configuration example of an image display device according to one embodiment.

FIG. 2 is a schematic plan view of a light guide of the image display device of FIG. 1 when viewed from a display element.

FIG. 3 is a schematic plan view of the light guide of the image display device of FIG. 1 when viewed from a field of view region.

FIG. 4 is an explanatory view of one example of wave vectors of the light guide of the image display device of FIG. 1.

FIG. 5 is a schematic explanatory view of a configuration example of a projection optical system of the image display device of FIG. 1.

FIG. 6 is an explanatory view of a first example of propagation of image light rays conducted by the light guide of the image display device of FIG. 1.

FIG. 7 is an explanatory view of a second example of propagation of image light rays conducted by the light guide of the image display device of FIG. 1.

FIG. 8 is an explanatory view of a first example of propagation of image light rays conducted by a light guide of a comparative example.

FIG. 9 is an explanatory view of a second example of propagation of image light rays conducted by the light guide of the comparative example.

FIG. 10 is an explanatory view of a third example of propagation of image light rays conducted by the light guide of the comparative example.

FIG. 11 is an explanatory view of a fourth example of propagation of image light rays conducted by the light guide of the comparative example.

FIG. 12 is a detailed explanatory view of the fourth example of propagation of image light rays conducted by the light guide of the comparative example.

FIG. 13 is an explanatory view of a third example of propagation of image light rays conducted by the light guide of the image display device of FIG. 1.

FIG. 14 is an explanatory view of a fourth example of propagation of image light rays conducted by the light guide of the image display device of FIG. 1.

FIG. 15 is an explanatory view of a fifth example of propagation of image light rays conducted by the light guide of the comparative example.

FIG. 16 is an explanatory view of a sixth example of propagation of image light rays conducted by the light guide of the comparative example.

FIG. 17 is a schematic perspective view of a configuration example of an image display device according to variation 1.

FIG. 18 is a schematic plan view of a light guide according to variation 2 when viewed from a display element.

FIG. 19 is a schematic plan view of the light guide according to variation 2 when viewed from a field of view region.

FIG. 20 is a plan view of a configuration example of a first diffraction grating of a reproduction region of the light guide of variation 2.

### DESCRIPTION OF EMBODIMENTS

Hereinafter, embodiments will be described in detail with reference to appropriate drawings. Note that, description more detailed than necessary will be omitted. For example, detailed description of well-known matters or duplicate description of substantially the same components may be omitted. This aims to avoid the following description from becoming more redundant than necessary and to facilitate understanding of persons skilled in the art. The inventor(s) provides the following description and attached drawings for making persons skilled in the art understand the present disclosure only and has no intention to limit subject matters claimed in claims.

A positional relationship such as an upward, downward, left, or right direction is assumed to be based on a positional relationship illustrated in Figures, unless otherwise noted. Figures referred to in the following embodiments are schematic figures. There is no guarantee that size or thickness ratios of individual components in each Figure always reflect actual dimensional ratios thereof. The dimensional ratios of the individual components are not limited to those illustrated in Figures.

In the present disclosure, expressions “travel in_direction” and “propagate in_direction” used in relation to light rays mean that a light ray forming an image travels in the_direction as a whole and therefore light beams included in the light ray forming the image may be permitted to be inclined relative to the_direction. For example, regarding a “light ray traveling in_direction”, it is sufficient that a main light beam of this light is directed in the_direction, and auxiliary beams of this light may be inclined relative to the_direction.

### 1. EMBODIMENTS

### 1.1 Configuration

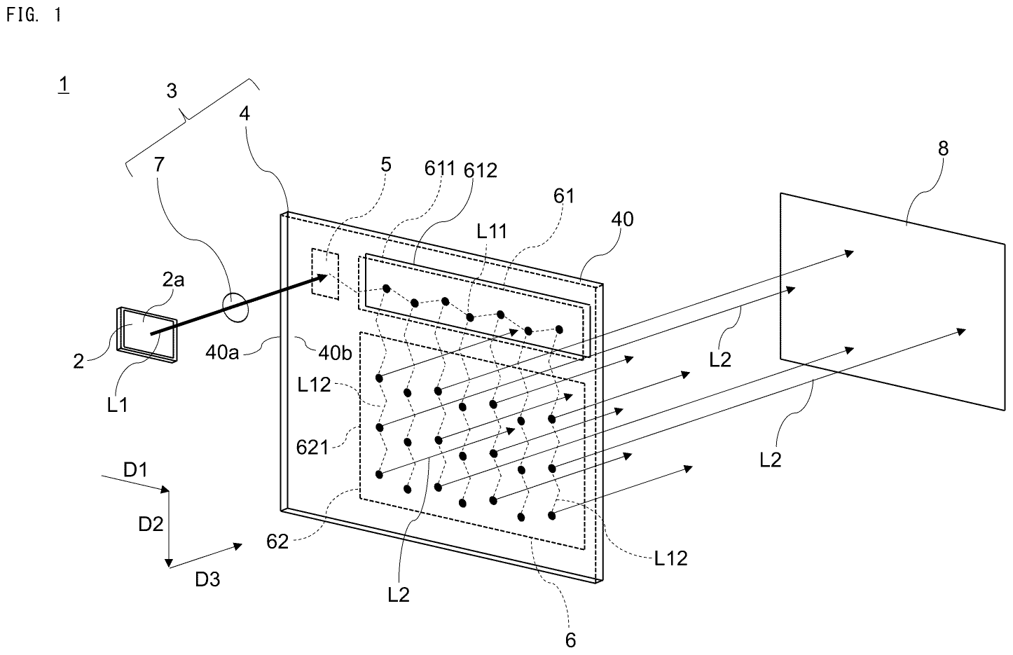

FIG. 1 is a schematic view of a configuration example of an image display device 1. The image display device 1 is, for example, a head mounted display (HMD) which is mounted on a user's head and displays an image (picture). As shown in FIG. 1, the image display device 1 includes a display element 2 and an optical system 3.

The display element 2 is configured to, in order to display an image (picture), output an image light ray L1 for forming an image. The image light ray L1 includes light beams output from respective points of the display element 2. The respective points of the display element 2 correspond to respective pixels of the display element 2, for example. The image displayed by the display element 2 has a first direction D1 and a second direction D2 perpendicular to each other. In the present embodiment, a dimension in the first direction D1 of the image is larger than a dimension in the second direction D2 of the image. In other words, the display element 2 includes an image display region 2a having the first direction D1 and the second direction D2 perpendicular to each other and a dimension in the first direction D1 of the image display region 2a is larger than a dimension in the second direction D2 of the image display region 2a. For example, a ratio of the dimension in the first direction D1 to the dimension in the second direction D2 is 3:1. In one example, the first direction D1 is a horizontal direction of the image and the second direction D2 is a vertical direction of the image. A direction D3 of an optical axis of the display element 2 is perpendicular to the first direction D1 and the second direction D2. The optical axis of the display element 2 is an optical axis of the image light ray L1, for example. The optical axis of the image light ray L1 is an optical axis of a ray output from a center of the display element 2, for example. Examples of the display element 2 may include known displays such as liquid crystal displays, organic EL displays, scanning MEMS mirrors, MS mirrors, LCOS (Liquid Crystal On Silicon), DMD (Digital Mirror Device), Micro LED, or the like.

As shown in FIG. 1, the optical system 3 is configured to guide the image light ray L1 output from the display element 2 toward the field of view region 8 set relative to eyes of the user. Within the field of view region 8, the user can watch by his or her own eyes the image formed by the display element 2 with the image not being interrupted. Especially, in the present embodiment, the optical system 3 expands the field of view region 8 by reproducing a pupil of the image light ray L1. In the present embodiment, the field of view region 8 is defined by a rectangular plane.

As shown in FIG. 1, the optical system 3 includes a light guide 4 and a projection optical system 7.

The light guide 4 is configured to guide image light ray L1 which is output from the display element 2 and forms the image, toward the field of view region 8 of the user, as a virtual image.

As shown in FIG. 1, the light guide 4 includes a body 40, an in-coupling region 5, and a reproduction region 6.

The body 40 is made of material transparent in a visible light region. The body 40 has a plate shape. In the present embodiment, the body 40 has a rectangular plate shape. The body 40 includes a first surface 40a and a second surface 40b in a thickness direction of the body 40. As shown in FIG. 1, the body 40 is positioned or arranged to direct the first surface 40a toward the display element 2 and the second surface 40b toward the field of view region 8.

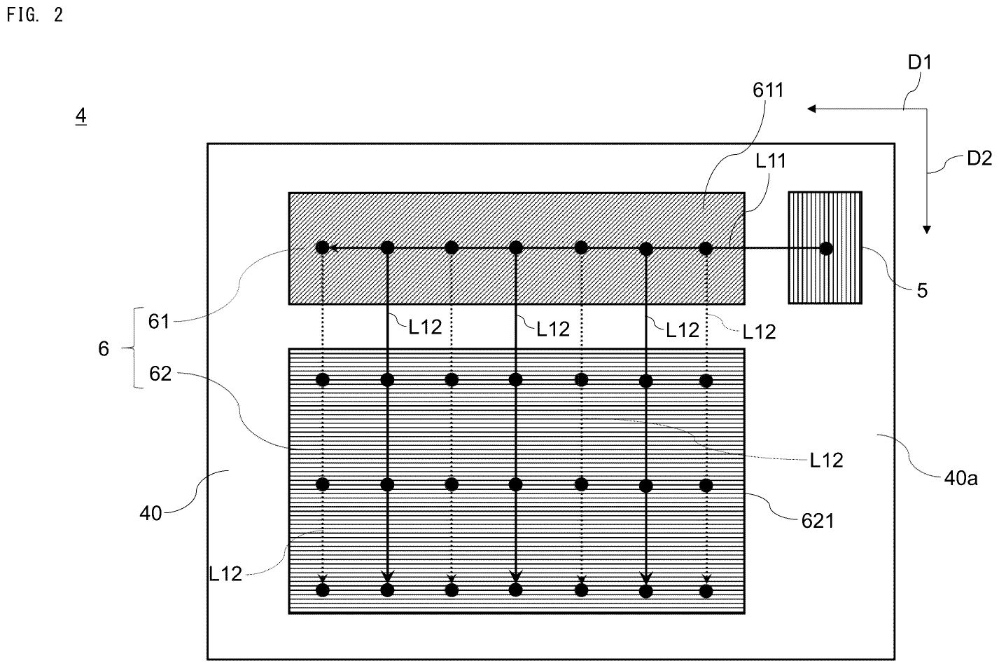

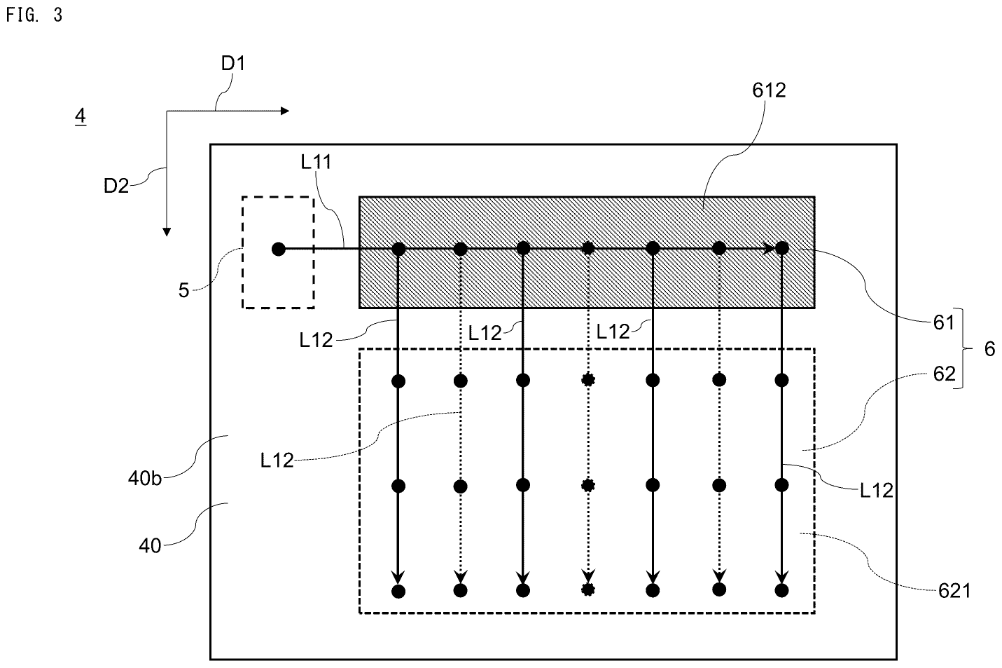

FIG. 2 is a schematic plan view of the light guide 4 when viewed from the display element 2. FIG. 3 is a schematic plan view of the light guide 4 when viewed from the field of view region 8.

The in-coupling region 5 is configured to allow the image light ray L1 to enter the body 40 so that the image light ray L1 propagates inside the body 40. In the present embodiment, the in-coupling region 5 allows the image light ray L1 to enter the body 40 so that the image light ray L1 propagates inside the body 40 in a first propagation direction (a left direction in FIG. 2 and a right direction in FIG. 3) perpendicular to the thickness direction of the body 40. The first propagation direction is a direction corresponding to the first direction D1. In the present embodiment, the first propagation direction is parallel to the first direction D1. In the present embodiment, the in-coupling region 5 is used for coupling between the display element 2 and the light guide 4. The in-coupling region 5 allows the image light ray L1 to be incident on the light guide 4 and propagate within the body 40 under a total reflection condition. The term “coupling” used herein means allowing propagation inside the body 40 of the light guide 4 under a total reflection condition.

The in-coupling region 5 is constituted by a diffraction structure causing diffraction effect for the image light ray L1. The diffraction structure of the in-coupling region 5 is a transmission surface-relief diffraction grating, for example. The diffraction structure of the in-coupling region 5 includes recessed or protruded parts arranged periodically. The diffraction structure of the in-coupling region 5 may include a plurality of recessed or protruded parts which extend in a predefined direction (a downward direction in FIG. 2 and FIG. 3) perpendicular to the thickness direction of the body 40 and intersecting the first propagation direction and are arranged at a predetermined interval in the first propagation direction, for example. In the present disclosure, the “diffraction structure” also may be a “periodic structure” where a plurality of recessed or protruded parts are arranged periodically. In some cases, depending on manufacture constraints or other situations, the “diffraction structure” may mean incomplete periodic structures in addition to the “periodic structure”. In the present embodiment, the predefined direction is a direction corresponding to the second direction D2. In the present embodiment, the predefined direction is parallel to the second direction D2. Therefore, the first propagation direction and the predefined direction are perpendicular to each other within a predetermined plane perpendicular to the thickness direction of the body 40. The in-coupling region 5 uses diffraction to allow the image light ray L1 to be incident on the body 40 to meet a condition where it is totally reflected by the first surface 40a and the second surface 40b. The in-coupling region 5 allows the image light ray L1 to travel in the first propagation direction within the body 40 while being totally reflected by the first surface 40a and the second surface 40b.

A size of the in-coupling region 5 is set to allow part of a whole of the image light ray L1 from the display element 2 through the projection optical system 7 to be incident on the in-coupling region 5. In the present embodiment, as shown in FIG. 2, the in-coupling region 5 has a quadrilateral shape.

The reproduction region 6 is formed at the body 40. The reproduction region 6 divides the image light ray L1 propagating in the first propagation direction intersecting the thickness direction of the body 40 in the first propagation direction, into a plurality of image light rays L1 propagating in a second propagation direction intersecting the first propagation direction. Hereinafter, for the purpose of simplifying the description only, to distinguish the image light ray L1 incident on the light guide 4 from other image light rays L1, the image light ray L1 propagating in the first propagation direction inside the body 40 may be denoted by an image light ray L11, and the image light ray L1 propagating in the second propagation direction inside the body 40 may be denoted by an image light ray L12.

The reproduction region 6 further divides the plurality of image light rays L12 propagating in the second propagation direction in the second propagation direction, into a plurality of image light rays L1 toward the field of view region 8. Hereinafter, for the purpose of simplifying the description only, to distinguish the image light rays L1 emerging from the light guide 4 from other image light rays L1, the plurality of image light rays L1 traveling from the light guide 4 toward the field of view region 8 may be denoted by image light rays L2.

In the reproduction region 6, the first propagation direction is a direction corresponding to the first direction D1. In the present embodiment, the first propagation direction is parallel to the first direction D1. The second propagation direction is a direction corresponding to the second direction D2. In the present embodiment, the second propagation direction is parallel to the second direction D2. Therefore, the first propagation direction and the second propagation direction intersect each other in a predetermined plane perpendicular to the thickness direction of the body 40. Especially, the second propagation direction is perpendicular to the first propagation direction.

The reproduction region 6 of FIG. 2 and FIG. 3 includes a dividing diffraction structure 61 and an exit diffraction structure 62.

The dividing diffraction structure 61 divides the image light ray L11 propagating in the first propagation direction, into the plurality of image light rays L12 propagating in the second propagation direction. As shown in FIG. 1 to FIG. 3, the dividing diffraction structure 61 includes a first diffraction structure region 611 and a second diffraction structure region 612.

The first diffraction structure region 611 and the second diffraction structure region 612 are formed respectively at the first surface 40a and the second surface 40b of the body 40 to face each other. The first diffraction structure region 611 and the second diffraction structure region 612 are positioned to be arranged in the first propagation direction side by side with the in-coupling region 5.

Each of the first diffraction structure region 611 and the second diffraction structure region 612 is a surface-relief diffraction grating. Each of the first diffraction structure region 611 and the second diffraction structure region 612 has recessed or protruded parts arranged periodically. Each of the first diffraction structure region 611 and the second diffraction structure region 612 is a reflection diffraction grating. Each of the first diffraction structure region 611 and the second diffraction structure region 612 is configured to divide a light ray propagating in the first propagation direction intersecting the thickness direction of the body 40 (the image light ray L11) into, a plurality of light rays propagating in the second propagation direction intersecting the first propagation direction (the image light rays L12), in the first propagation direction. The first diffraction structure region 611 and the second diffraction structure region 612 of the dividing diffraction structure 61 allows the plurality of image light rays L12 arranged in the first propagation direction to travel toward the exit diffraction structure 62, by dividing the image light ray L11 propagating inside the body 40 of the light guide 4. By doing so, the dividing diffraction structure 61 realizes pupil expansion of the image light ray L1 in the first propagation direction. In summary, as shown in FIG. 2 and FIG. 3, the dividing diffraction structure 61 reproduces in the first propagation direction, the pupil of the image light ray L1 projected by the projection optical system 7 to expand the pupil by dividing the image light ray L11 into the plurality of image light rays L12 which are parallel to each other and travel toward the exit diffraction structure 62. In FIG. 2, the image light rays L12 divided from the image light ray L11 by the first diffraction structure region 611 are represented by solid lines, and the image light rays L12 divided from the image light ray L11 by the second diffraction structure region 612 are represented by dotted lines. In FIG. 3, the image light rays L12 divided from the image light ray L11 by the first diffraction structure region 611 are represented by dotted lines, and the image light rays L12 divided from the image light ray L11 by the second diffraction structure region 612 are represented by solid lines.

As one example, each of the first diffraction structure region 611 and the second diffraction structure region 612 is constituted by plurality of recessed or protruded parts in relation to the thickness direction of the body 40 which are arranged to have periodicity in a periodic direction. The periodic direction is a direction where the recessed or protruded parts are arranged to have periodicity. The periodic direction includes a component of the first propagation direction. To convert the image light ray L11 propagating in the first propagation direction into the image light rays L12 propagating in the second propagation direction, the periodic direction is set to be a direction inclined relative to the first propagation direction. The periodic direction of the first diffraction structure region 611 or the second diffraction structure region 612 is a direction of a wave vector thereof. As one example, the periodic direction of the first diffraction structure region 611 is a direction inclined at 45 degrees relative to the first propagation direction within a plane perpendicular to the thickness direction of the body 40. In this case, the recessed or protruded parts of the first diffraction structure region 611 extend in a direction inclined at 45 degrees relative to the first propagation direction within a plane perpendicular to the thickness direction of the body 40. This allows conversion of the image light ray L11 propagating in the first propagation direction into the image light rays L12 propagating in the second propagation direction. The periodic direction is not limited to a direction inclined at 45 degrees relative to the first propagation direction within the plane perpendicular to the thickness direction of the body 40. For example, an angle of the periodic direction relative to the first propagation direction within the plane perpendicular to the thickness direction of the body 40 may be in a range of 20 degrees to 70 degrees.

Sizes of the first diffraction structure region 611 and the second diffraction structure region 612 are set to allow a whole of the image light ray L11 from the in-coupling region 5 to enter the first diffraction structure region 611 and the second diffraction structure region 612. In the present embodiment, as shown in FIG. 2, the first diffraction structure region 611 has a quadrilateral shape and as shown in FIG. 3, the second diffraction structure region 612 has a quadrilateral shape.

The exit diffraction structure 62 allows the plurality of image light rays L12 propagating in the second propagation direction to travel toward the field of view region 8. In the present embodiment, the exit diffraction structure 62 divides the plurality of image light rays L12 propagating in the second propagation direction from the dividing diffraction structure 61 into a plurality of image light rays in the second propagation direction, and allows them as the plurality of image light rays 2 traveling toward the field of view region 8. In summary, the exit diffraction structure 62 divides the plurality of image light rays L12 propagating in the second propagation direction from the dividing diffraction structure 61, into the plurality of image light rays L2 arranged in the second propagation direction and traveling toward the field of view region 8. As shown in FIG. 1 to FIG. 3, the exit diffraction structure 62 includes a third diffraction structure region 621.

The third diffraction structure region 621 is formed at the first surface 40a of the body 40 and has periodicity in the second propagation direction. The third diffraction structure region 621 may include a plurality of recessed or protruded parts which extend in the first propagation direction within the plane perpendicular to the thickness direction of the body 40 and arranged at a predetermined interval in the second propagation direction, for example. The third diffraction structure region 621 is located to be arranged side by side with the first diffraction structure region 611 and the second diffraction structure region 612 of the dividing diffraction structure 61 in the second propagation direction.

The third diffraction structure region 621 is a surface-relief diffraction grating. The third diffraction structure region 621 includes recessed or protruded parts arranged periodically. The third diffraction structure region 621 is a transmission diffraction grating. The third diffraction structure region 621 is configured to divide a light ray propagating in the second propagation direction intersecting the thickness direction of the body 40 (the image light ray L12) into a plurality of light rays traveling toward the field of view region 8 (the image light rays L2), in the second propagation direction. The third diffraction structure region 621 divides the image light ray L12 propagating inside the body 40 of the light guide 4 to allow the plurality of image light rays L2 arranged in the second propagation direction to travel toward the field of view region 8. By doing so, the third diffraction structure region 621 realizes pupil extension of the image light ray L1 in the second propagation direction. In summary, as shown in FIG. 1, the third diffraction structure region 621 reproduces the pupil of the image light ray L1 projected by the projection optical system 7 to expand the pupil, by dividing the image light ray L12 into the plurality of image light rays L2 traveling toward the field of view region 8.

In the present embodiment, the plurality of image light rays L2 are parallel to each other. The meaning of the phrase “the plurality of image light rays L2 are parallel to each other” may not be limited to the meaning that the plurality of image light rays L2 are parallel to each other in the strict sense but may include the meaning that the plurality of image light rays L2 are almost parallel to each other. The plurality of image light rays L2 may not be required to be parallel to each other in the strict sense and it is sufficient that directions of the plurality of image light rays L2 are aligned such that the plurality of image light rays L2 are considered to be parallel to each other in the optical design. When the plurality of image light rays L2 are parallel to each other, it is possible to improve uniformity of arrangement of the pupil of the image light ray L2 in the field of view region 8, and this may result in reduction of an area of the field of view region 8 where no pupil of the image light ray L2 is located.

A size of the third diffraction structure region 621 is set to allow a whole of the image light ray L12 from the dividing diffraction structure 61 to enter the third diffraction structure region 621. In the present embodiment, as shown in FIG. 2, the third diffraction structure region 621 has a quadrilateral shape.

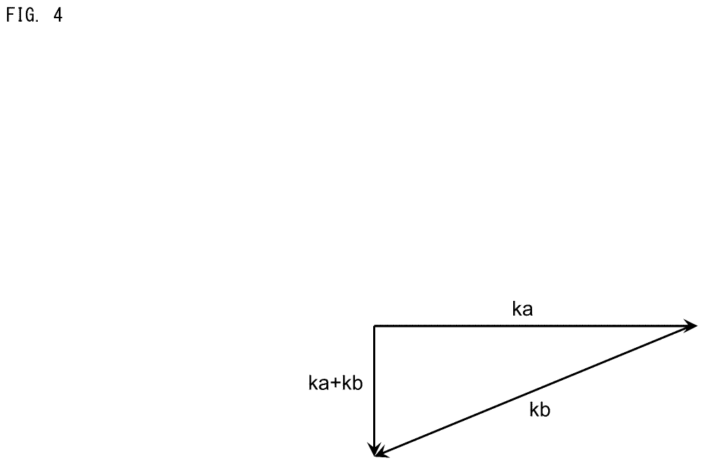

In the light guide 4, respective wave vectors of the in-coupling region 5 and the reproduction region 6 are set as follows. FIG. 4 is an explanatory view of one example of the wave vectors of the light guide 4. As shown in FIG. 4, the wave vector of the in-coupling region 5 is denoted by ka and the wave vector of the dividing diffraction structure 61 of the reproduction region 6 is denoted by kb. The wave vector ka is a vector of the first propagation direction, and the wave vector kb is a vector allowing ka+kb to be a vector of the second propagation direction. Components of the wave vector may be set based on an arbitrary plane perpendicular to the thickness direction of the body 40, for example. In this case, a center of the in-coupling region 5 may be selected as an original point of the arbitrary plane. As shown in FIG. 4, the wave vectors ka and kb satisfy a relation of |ka|>|ka+kb|. Accordingly, a propagation angle of the image light ray L12 propagating in the second propagation direction can be smaller than a propagation angle of the image light ray L11 propagating in the first propagation direction. This enables improvement of a pupil filling factor in the second propagation direction. Further, when the wave vectors ka and kb satisfy a relation of |ka|>1.1×|ka+kb|, the propagation angle of the image light ray L12 propagating in the second propagation direction can be close to an angle satisfying a total reflection condition. Therefore, it is possible to further improve the pupil filling factor in the second propagation direction.

As described above, the light guide 4 divides, inside the body 40, the image light ray L11 entering the body 40 of the light guide 4 from the in-coupling region 5 into the plurality of image light rays L12 arranged in the first propagation direction and propagating in the second propagation direction, and further divides each image light ray L12 into the plurality of image light rays L2 arranged in the second propagation direction and traveling toward the field of view region 8, thereby reproducing the pupil of the image light ray L1 in the first propagation direction and the second propagation direction to expand the pupil.

The projection optical system 7 projects the image light ray L1 which is output from the display element 2 and forms the image. As shown in FIG. 1, the projection optical system 7 is positioned between the display element 2 and the in-coupling region 5 of the light guide 4. Thus, the projection optical system 7 allows the image light ray L1 from the display element 2 to be incident on the in-coupling region 5 of the light guide 4. The projection optical system 7 collimates the image light ray L1 from the display element 2 and allows it to be incident on the in-coupling region 5, for example. The projection optical system 7 allows the image light ray L1 to be incident on the in-coupling region 5 as a substantial collimated light ray. In FIG. 1, just for the purpose of simplification of the drawing, the projection optical system 7 is depicted as a single optical element. In the present embodiment, the projection optical system 7 is constituted by a plurality of optical elements.

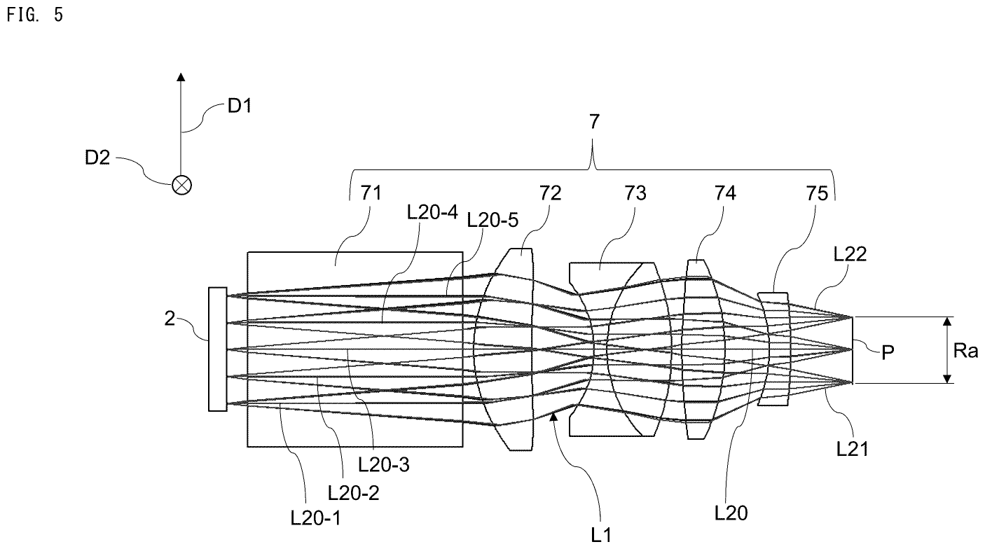

FIG. 5 is a schematic explanatory view of a configuration example of the projection optical system 7 of the image display device 1. FIG. 5 shows an illustration viewed in the second direction D2. The projection optical system 7 includes a plurality of optical elements constituted by first to fifth optical elements 71 to 75. In this case, an LCOS is used as the display element 2. The first optical element 71 is a PBS prism, for example. The second optical element 72 is a positive meniscus lens with an aspheric shape, for example. The third optical element 73 is a compound lens where a biconcave lens and a biconvex lens are combined, for example. The fourth optical element 74 is a biconvex lens, for example. The fifth optical element 75 is a negative meniscus lens, for example.

As shown in FIG. 5, the image light ray L1 includes a main light beam L20 corresponding to a center of the virtual image, and a first auxiliary light beam L21 and a second auxiliary light beam L22 which come closer to the main light beam L20 as traveling from the projection optical system 7 toward the in-coupling region 5. The first auxiliary light beam L21 and the second auxiliary light beam L22 define outermost edges of the image light ray L1 in a plane perpendicular to the second direction D2.

As shown in FIG. 5, the projection optical system 7 has an entrance pupil P relative to the display element 2. The entrance pupil P corresponds to an aperture stop of the projection optical system 7. A position of the entrance pupil P is a position where central light beams L20-1 to L20-5 of light fluxes output from respective points of the display element 2 constituting the image light ray L1 intersect an optical axis of the projection optical system 7 when viewed in a section parallel to the optical axis.

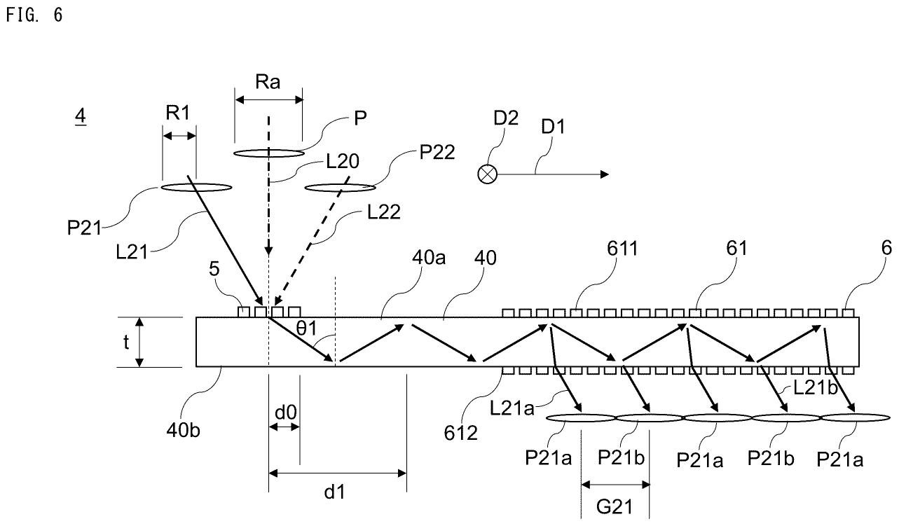

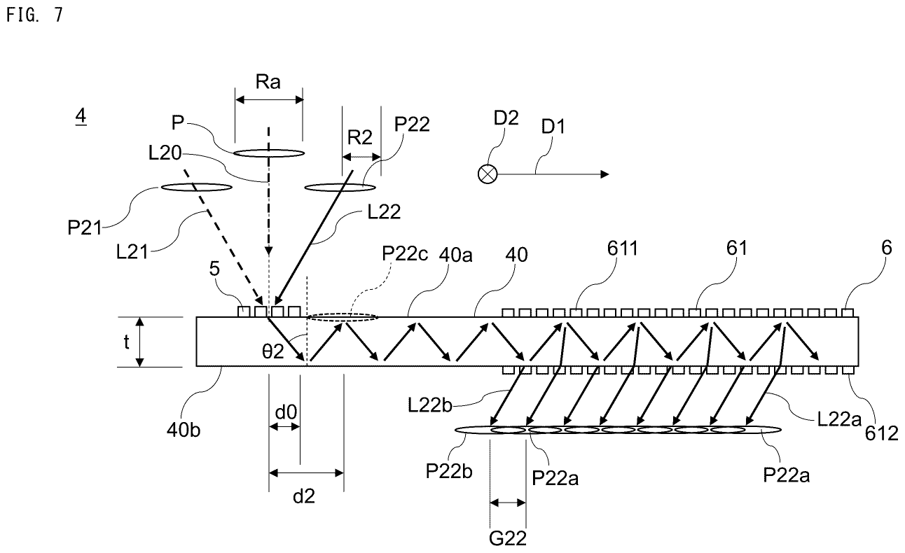

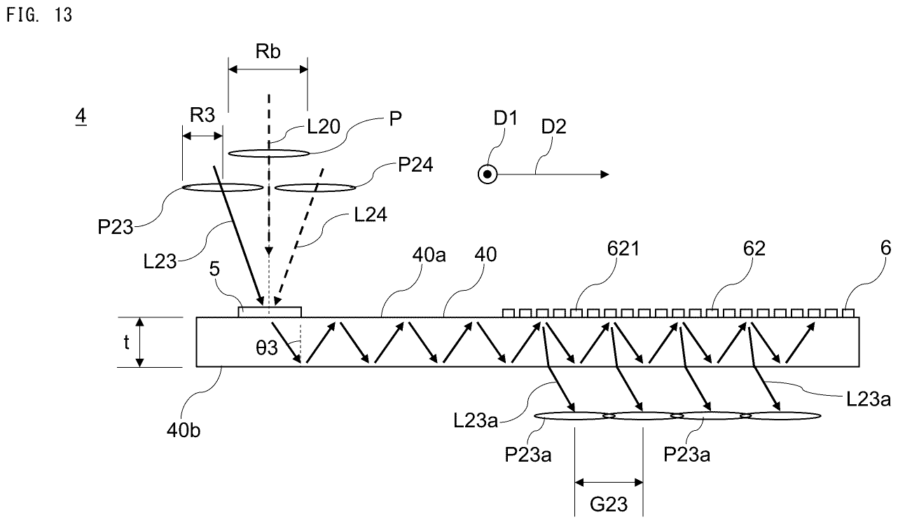

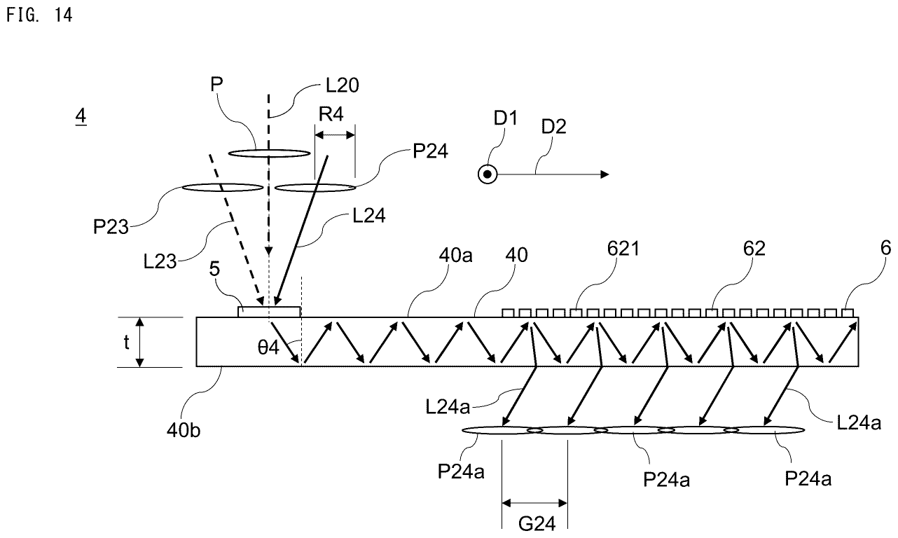

In the present embodiment, the entrance pupil P of the projection optical system 7 has a first direction and a second direction. The first direction of the entrance pupil P is a direction corresponding to the first direction D1 of the image, and the second direction of the entrance pupil P is a direction corresponding to the second direction D2 of the image. In the present embodiment, the first direction of the entrance pupil P is identical to the first direction D1 of the image and the second direction of the entrance pupil P is identical to the second direction D2 of the image. The projection optical system 7 is configured so that a first dimension in the first direction of the entrance pupil P is smaller than a second dimension in the second direction of the entrance pupil P. Especially, when the first dimension of the entrance pupil P is denoted by Ra (see FIG. 5, FIG. 6, FIG. 7) and the second dimension of the entrance pupil P is denoted by Rb (see FIG. 13, FIG. 14), the first dimension Ra and the second dimension Rb satisfy a relation of 0.3<Ra/Rb<0.7.

In the present embodiment, the virtual image has a first direction and a second direction. The first direction of the virtual image is a direction corresponding to the first direction D1 of the image, and the second direction of the virtual image is a direction corresponding to the second direction D2 of the image. In the present embodiment, the first direction of the virtual image is identical to the first direction D1 of the image and the second direction of the virtual image is identical to the second direction D2 of the image. The projection optical system 7 is configured so that a first field of view angle in the first direction of the virtual image is larger than a second field of view angle in the second direction of the virtual image. Especially, when the first field of view angle of the virtual image is denoted by FOV1 and the second field of view angle of the virtual image is denoted by FOV2, the first field of view angle FOV1 and the second field of view angle FOV2 satisfy a relation of FOV2/FOV1<0.5. As one example, the first field of view angle FOV1 is represented by FOV1=tan⁻¹ (dₕ/2d_{f1}), wherein d_{f1} denotes a distance between the display element 2 and a focal point of the projection optical system 7 in a plane including the first direction D1 of the image and the optical axis of the image and dₕ denotes a dimension in the first direction D1 of the image. As one example, the second field of view angle FOV2 is represented by FOV2=tan⁻¹(dᵥ/2d_{f2}), wherein d_{f2} denotes a distance between the display element 2 and the focal point of the projection optical system 7 in a plane including the second direction D1 of the image and the optical axis of the image and dᵥ denotes a dimension in the second direction D2 of the image.

### 1.2 Light Propagation Conducted by Light Guide

Hereinafter, description is made to examples of propagation of image light rays conducted by the light guide 4 of the image display device 1 of the present embodiment.

FIG. 6 is an explanatory view of a first example of propagation of image light rays conducted by the light guide 4 of the image display device 1. FIG. 7 is an explanatory view of a second example of propagation of image light rays conducted by the light guide 4 of the image display device 1. The first example and the second example of propagation of image light rays conducted by the light guide 4 of the image display device 1 relate to propagation in the first propagation direction of image light rays.

As shown in FIG. 6 and FIG. 7, the image light ray includes the main light beam L20 corresponding to the center of the virtual image, and the first auxiliary light beam L21 and the second auxiliary light beam L22 which respectively define outermost edges of the image light ray in a plane perpendicular to the second direction D2. In FIG. 6, the first auxiliary light beam L21 and the reproduction region 6 are on opposite sides of the main light beam L20, and the second auxiliary light beam L22 and the reproduction region 6 are on the same side of the main light beam L20.

The first auxiliary light beam L21 is the largest in the propagation angle of light beams in the image light ray propagating in the first propagation direction. As shown in FIG. 6, when a radius of an entrance pupil P21 of the first auxiliary light beam L21 in the first propagation direction is denoted by R1, the radius R1 is determined by the first dimension Ra in the direction corresponding to the first direction D1 of the entrance pupil P of the projection optical system 7. As one example, the radius R1 and the first dimension Ra satisfy a relation of R1=Ra/2.

The second auxiliary light beam L22 is the smallest in the propagation angle of light beams in the image light ray propagating in the first propagation direction. As shown in FIG. 7, when a radius of an entrance pupil P22 of the second auxiliary light beam L22 in the first propagation direction is denoted by R2, the radius R2 is determined by the first dimension Ra in the direction corresponding to the first direction D1 of the entrance pupil P of the projection optical system 7. As one example, the radius R2 and the first dimension Ra satisfy a relation of R2=Ra/2.

An angle between the first auxiliary light beam L21 and the second auxiliary light beam L22 corresponds to the first field of view angle FOV1 of the virtual image.

Referring to FIG. 6, the first auxiliary light beam L21 is coupled to the light guide 4 by the in-coupling region 5, propagates inside the body 40 of the light guide 4 in the first propagation direction while being totally reflected by the first surface 40a and the second surface 40b of the body 40, and reaches the reproduction region 6. The first auxiliary light beam L21 is divided in the first propagation direction and directed in the second propagation direction by the dividing diffraction structure 61. The first diffraction structure region 611 of the dividing diffraction structure 61 divides the first auxiliary light beam L21 into a plurality of first auxiliary light beams L21a. The second diffraction structure region 612 of the dividing diffraction structure 61 divides the first auxiliary light beam L21 into a plurality of first auxiliary light beams L21b. The plurality of first auxiliary light beams L21a and 21b are made to emerge toward the field of view region 8 by the exit diffraction structure 62. In the field of view region 8, pupils P21a of image light rays by the plurality of first auxiliary light beams L21a and pupils P21b of image light rays by the plurality of first auxiliary light beams L21b are arranged alternately in the first propagation direction.

When the propagation angle of the first auxiliary light beam L21 is denoted by θ1 and a thickness of the body 40 of the light guide 4 is denoted by t, an interval G21 between the adjacent pupils P21a and P21b is given by t×tan θ1. An increase in the interval G21 relative to the entrance pupil P21 of the first auxiliary light beam L21 in the first propagation direction may result in an increase in the area of the field of view region 8 where the pupil P21a or P21b is absent. A decrease in the interval G21 relative to the entrance pupil P21 of the first auxiliary light beam L21 in the first propagation direction may result in an increase in an area of the field of view region 8 where the pupils P21a and P21b overlap each other, which is wasteful. In view of this point, the optical system 3 is configured to allow the thickness t, the propagation angle θ1 and the radius R1 to satisfy a relation of 1.6<(t×tan θ1)/R1<2.4. Accordingly, it is possible to reduce the area of the field of view region 8 where any of the pupils P21a and P21b of the first auxiliary light beam L21 of the image light ray is not located in the first propagation direction. In summary, it is possible to improve the filling factor of the pupil of the image light ray in the field of view region 8 in the first propagation direction. Further, it is possible to reduce an excess increase in an overlap area of the pupils P21a and P21b and reduce waste use of the image light ray.

Referring to FIG. 7, the second auxiliary light beam L22 is coupled to the light guide 4 by the in-coupling region 5, propagates inside the body 40 of the light guide 4 in the first propagation direction while being totally reflected by the first surface 40a and the second surface 40b of the body 40, and reaches the reproduction region 6. The second auxiliary light beam L22 is divided in the first propagation direction and directed in the second propagation direction by the dividing diffraction structure 61. The first diffraction structure region 611 of the dividing diffraction structure 61 divides the second auxiliary light beam L22 into a plurality of second auxiliary light beams L22a. The second diffraction structure region 612 of the dividing diffraction structure 61 divides the second auxiliary light beam L22 into a plurality of second auxiliary light beams L22b. The plurality of second auxiliary light beams L22a and 22b are made to emerge toward the field of view region 8 by the exit diffraction structure 62. In the field of view region 8, pupils P22a of image light rays by the plurality of second auxiliary light beams L22a and pupils P22b of image light rays by the plurality of second auxiliary light beams L22b are arranged alternately in the first propagation direction.

When the propagation angle of the second auxiliary light beam L22 is denoted by θ2 and the thickness of the body 40 of the light guide 4 is denoted by t, an interval G22 between the adjacent pupils P22a and P22b is given by t×tan θ2. It is supposed that the propagation angles θ1 and θ2 satisfy a relation of θ1>θ2 and the radii R1 and R2 are equal to each other. When the thickness t, the propagation angle θ1 and the radius R1 satisfy the relation of 1.6<(t×tan θ1)/R1<2.4, the thickness t, the propagation angle θ2 and the radius R2 satisfy a relation of 1.6<(t×tan θ2)/R2<2.4. Therefore, it is possible to reduce the area of the field of view region 8 where any of the pupils P22a and P22b is not located.

As shown in FIG. 7, the second auxiliary light beam L22 is coupled to the light guide 4 by the in-coupling region 5 and propagates inside the body 40 of the light guide 4 in the first propagation direction while being totally reflected by the first surface 40a and the second surface 40b of the body 40. A distance from the center of the in-coupling region 5 to a position where the second auxiliary light beam L22 is totally reflected by the first surface 40a at first time is denoted by d2. The distance d2 is given by 2×t×tan θ2. When the in-coupling region 5 overlaps a pupil P22c at the position where the second auxiliary light beam L22 is totally reflected by the first surface 40a at first time, there is possibility that part of the second auxiliary light beam L22 may emerge outside from the in-coupling region 5. When part of the second auxiliary light beam L22 emerges outside from the in-coupling region 5, a use efficiency of the image light ray may decrease. In view of this point, when a half value of a dimension in the first propagation direction of the in-coupling region 5 is denoted by d0, the optical system 3 is configured to allow the thickness t, the propagation angle θ2, the radius R2 and the half value d0 to satisfy a relation of 0.7<(2×t×tan θ2)/(R2+d0)<1.5. Accordingly, it is possible to reduce possibility that the second auxiliary light beam L22 is extracted from the in-coupling region 5. In summary, it is possible to improve the use efficiency of the image light ray in the first propagation direction.

Referring to FIG. 6, a distance from the center of the in-coupling region 5 to a position where the first auxiliary light beam L21 is totally reflected by the first surface 40a at first time is denoted by d1. The distance d1 is given by 2×t×tan θ1. It is supposed that the propagation angles θ1 and θ2 satisfy a relation of θ1>θ2 and the radii R1 and R2 are equal to each other. When the thickness t, the propagation angle θ2, the radius R2 and the half value d0 satisfy the relation of 0.7<(2×t×tan θ2)/(R2+d0)<1.5, the thickness t, the propagation angle θ1, the radius R1 and the half value d0 satisfy a relation of 0.7<(2×t×tan θ1)/(R1+d0)<1.5. Accordingly, it is possible to reduce possibility that the first auxiliary light beam L21 is extracted from the in-coupling region 5. In summary, it is possible to improve the use efficiency of the image light ray in the first propagation direction.

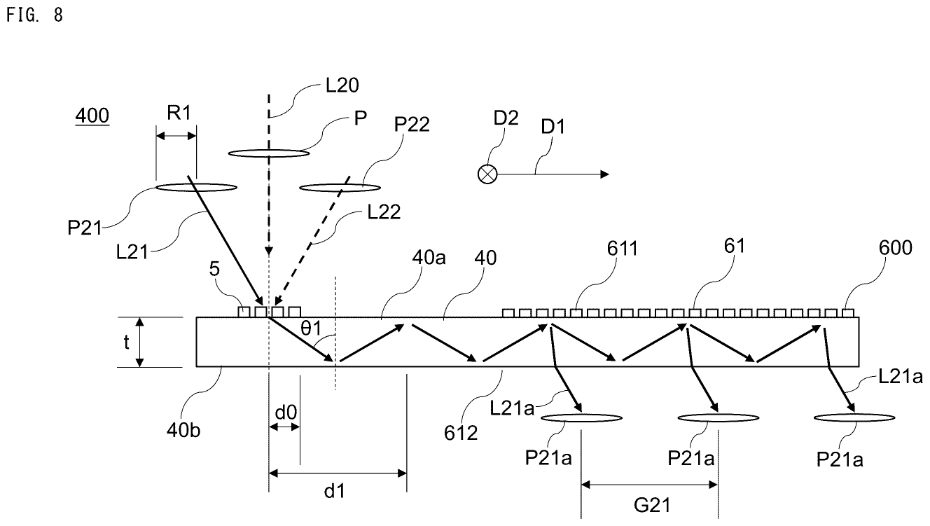

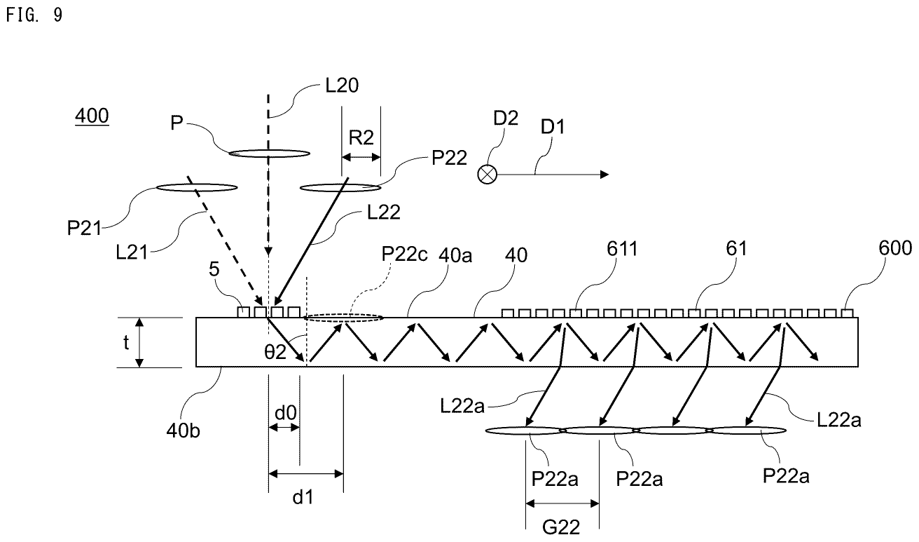

FIG. 8 is an explanatory view of a first example of propagation of an image light ray by a light guide 400 of an image display device according to a comparative example. FIG. 9 is an explanatory view of a second example of propagation of the image light ray by the light guide 400 of the image display device according to the comparative example. The first example and the second example of propagation of the image light ray by the light guide 400 of the image display device according to the comparative example relate to propagation of the image light ray in the first propagation direction.

The light guide 400 of the image display device according to the comparative example shown in FIG. 8 and FIG. 9 is different from the light guide 4 in configuration of the reproduction region. The reproduction region 600 of the light guide 400 does not include the second diffraction structure region 612 and the dividing diffraction structure 61 includes the first diffraction structure region 611 only.

Referring to FIG. 8, the first auxiliary light beam L21 is coupled to the light guide 400 by the in-coupling region 5, propagates inside the body 40 of the light guide 400 in the first propagation direction while being totally reflected by the first surface 40a and the second surface 40b of the body 40, and reaches the reproduction region 600. The first auxiliary light beam L21 is divided in the first propagation direction and is directed in the second propagation direction by the dividing diffraction structure 61. The first diffraction structure region 611 of the dividing diffraction structure 61 divides the first auxiliary light beam L21 into a plurality of first auxiliary light beams L21a. The plurality of first auxiliary light beams L21a are made to emerge toward the field of view region 8 by the exit diffraction structure 62. In the field of view region 8, the pupils P21a of the image light rays by the plurality of first auxiliary light beams L21a are arranged in the first propagation direction. In comparison to the light guide 4 of FIG. 6, the pupils P21b of the image light rays by the plurality of first auxiliary light beams L21b by the second diffraction structure region 612 are absent. Therefore, as shown in FIG. 8, there may be a comparatively large gap between the pupils 21a and therefore the field of view region 8 may easily show an area where no pupil 1a of the first auxiliary light beam L21 of the image light ray is located.

Referring to FIG. 9, the second auxiliary light beam L22 is coupled to the light guide 400 by the in-coupling region 5, propagates inside the body 40 of the light guide 400 in the first propagation direction while being totally reflected by the first surface 40a and the second surface 40b of the body 40, and reaches the reproduction region 600. The second auxiliary light beam L22 is divided in the first propagation direction and is directed in the second propagation direction by the dividing diffraction structure 61. The first diffraction structure region 611 of the dividing diffraction structure 61 divides the second auxiliary light beam L22 into a plurality of second auxiliary light beams L22a. The plurality of second auxiliary light beams L22a are made to emerge toward the field of view region 8 by the exit diffraction structure 62. In the field of view region 8, the pupils P22a of the image light rays by the plurality of second auxiliary light beams L22a are arranged in the first propagation direction. In comparison to the light guide 4 of FIG. 7, the pupils P22b of the image light rays by the plurality of second auxiliary light beams L22b by the second diffraction structure region 612 are absent. The propagation angles θ1 and θ2 satisfy the relation of θ1>θ2. Therefore, in comparison to the pupils 21a of the image light rays by the first auxiliary light beams L21a, the pupils 22a of the image light rays by the second auxiliary light beams L22a may decrease in an area where no pupil is located.

In the light guide 400, the radius R1 of the entrance pupil P21 of the first auxiliary light beam L21 may be made greater to reduce the area of the field of view region 8 where no pupil P21a of the first auxiliary light beam L21 of the image light ray is located.

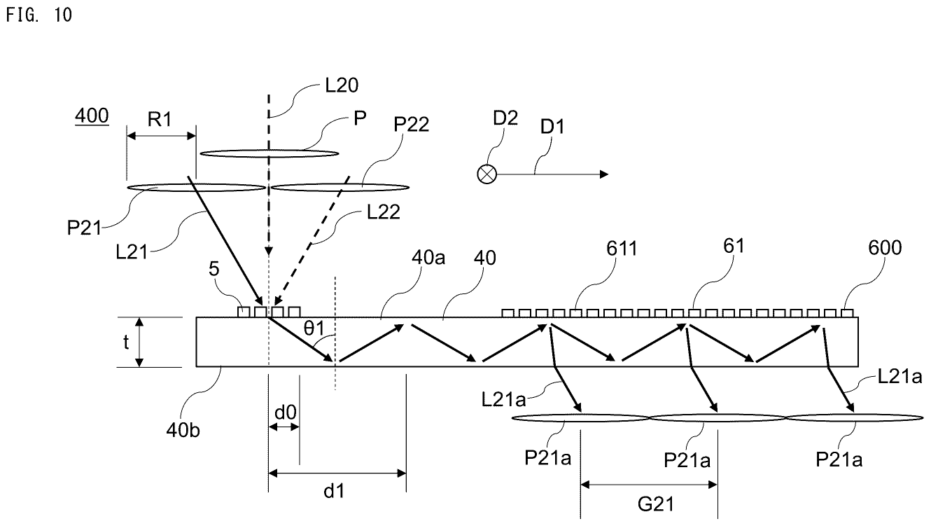

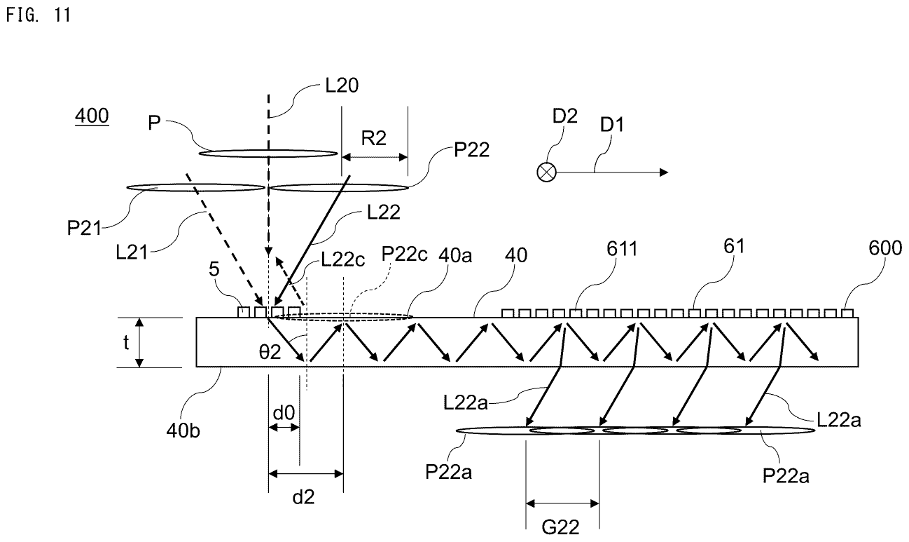

FIG. 10 is an explanatory view of a third example of propagation of the image light ray by the light guide 400 of the image display device according to the comparative example. FIG. 11 is an explanatory view of a fourth example of propagation of the image light ray by the light guide 400 of the image display device according to the comparative example. The third example and the fourth example of propagation of the image light ray by the light guide 400 of the image display device according to the comparative example relate to propagation of the image light ray in the first propagation direction.

Referring to FIG. 10, the radius R1 of the entrance pupil P21 of the first auxiliary light beam L21 is greater than the radius R1 of the entrance pupil P21 of the first auxiliary light beam L21 of FIG. 8. When the propagation angle of the first auxiliary light beam L21 is denoted by θ1 and the thickness of the body 40 of the light guide 4 is denoted by t, the interval G21 between the adjacent pupils P21a is given by 2×t×tan θ1. In one example, by setting the radius R1 so that the radius R1 satisfies a relation of 0.8<(t×tan θ1)/R1<1.2, it is expected that the area of the field of view region 8 where the pupil P21a of the first auxiliary light beam L21 of the image light ray is absent is reduced. FIG. 10 shows the gap between the pupils 21a is smaller than that of FIG. 8 and the area of the field of view region 8 where the pupil P21a of the first auxiliary light beam L21 of the image light ray is reduced.

However, an increase in the radius R1 of the entrance pupil P21 of the first auxiliary light beam L21 may cause an increase in the radius R2 of the entrance pupil P22 of the second auxiliary light beam L22.

Referring to FIG. 11, the radius R2 of the entrance pupil P22 of the second auxiliary light beam L22 is greater than the radius R2 of the entrance pupil P22 of the second auxiliary light beam L22 of FIG. 9. When the propagation angle of the second auxiliary light beam L22 is denoted by θ2 and the thickness of the body 40 of the light guide 4 is denoted by t, an interval G22 between the adjacent pupils P22a is given by 2×t×tan θ2. It is supposed that the propagation angles θ1 and θ2 satisfy the relation of θ1>θ2 and the radii R1 and R2 are equal to each other. When the thickness t, the propagation angle θ1 and the radius R1 satisfy the relation of 0.8<(t×tan θ1)/R1<1.2, the thickness t, the propagation angle θ2 and the radius R2 satisfy a relation of 0.8<(t×tan θ2)/R2<1.2. Therefore, it is possible to reduce the area of the field of view region 8 where no pupil P22a is located. However, FIG. 11 shows that an overlap between the pupils P22a in the field of view region 8 increases and this results in waste use.

Further, in FIG. 11, an overlap between the in-coupling region 5 and the pupil 22c at the position where the second auxiliary light beam L22 is totally reflected by the first surface 40a at first time is relatively large.

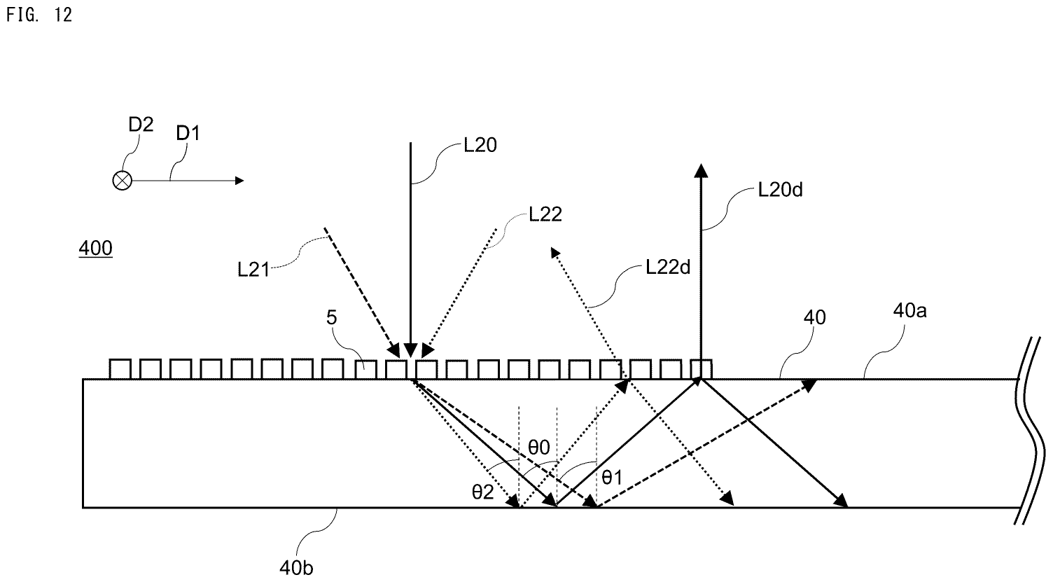

FIG. 12 is a detailed explanatory view of the fourth example of propagation of the image light ray by the light guide 400 according to the comparative example. In detail, FIG. 12 shows a situation where part of the image light ray is extracted outside from the in-coupling region 5 in the fourth example 4 of propagation of the image light ray by the light guide 400 according to the comparative example. As shown in FIG. 12, of the propagation angles θ0, θ1 and θ2 of the main light beam L20, the first auxiliary light beam L21 and the second auxiliary light beam L22, the propagation angle θ1 is the largest and the propagation angle θ2 is the smallest. A distance to a position where the image light ray is totally reflected by the first surface 40a at first time increases with an increase in the propagation angle. In FIG. 12, a position where the first auxiliary light beam L21 is totally reflected by the first surface 40a at first time is outside the in-coupling region 5 while positions where the main light beam L20 and the second auxiliary light beam L22 are totally reflected by the first surface 40a at first time is inside the in-coupling region 5. Therefore, a partial light ray L20d of the main light beam L20 and a partial light ray L22d of the second auxiliary light beam L22 are extracted by the in-coupling region 5 from the body 40 of the light guide 400 and this may cause a loss in the image light ray.

In the image display device 1 according to the present embodiment, the reproduction region 6 [symbol] the dividing diffraction structure 61 of the reproduction region 6 of the light guide 4 is a double-sided diffraction structure having the first diffraction structure region 611 and the second diffraction structure region 612 respectively formed at the first surface 40a and the second surface 40b of the body 40. Therefore, in the field of view region 8, the pupils P21a of the image light rays by the plurality of first auxiliary light beams L21a and the pupils P21b of the image light rays by the plurality of first auxiliary light beams L21b are arranged alternately in the first propagation direction. Therefore, the image display device 1 according to the present embodiment enables reduction in the area of the field of view region 8 where no pupil is located in the first propagation direction, without an increase in the radius R1 of the entrance pupil P21 of the first auxiliary light beam L21. Further, the image display device 1 according to the present embodiment does not require an increase in the radius R1 of the entrance pupil P21 of the first auxiliary light beam L21 and thus enables reduction of probability that the second auxiliary light beam L22 is extracted from the in-coupling region 5. In summary, it is possible to improve the use efficiency of the image light ray in the first propagation direction.

FIG. 13 is an explanatory view of a third example of propagation of the image light ray by the light guide 4 of the image display device 1. FIG. 14 is an explanatory view of a fourth example of propagation of the image light ray by the light guide 4 of the image display device 1. The third example and the fourth example of propagation of the image light ray by the light guide 4 of the image display device 1 relate to propagation of the image light ray in the second propagation direction.

As shown in FIG. 13 and FIG. 14, the image light ray includes the main light beam L20 corresponding to the center of the virtual image, and a third auxiliary light beam L23 and a fourth auxiliary light beam L24 which define outermost edges of the image light ray in a plane perpendicular to the first direction D1. In FIG. 13, the third auxiliary light beam L23 and the exit diffraction structure 62 of the reproduction region 6 are on opposite sides of the main light beam L20, and the fourth auxiliary light beam L24 and the exit diffraction structure 62 of the reproduction region 6 are on the same side of the main light beam L20.

The third auxiliary light beam L23 is the largest in the propagation angle of light beams in the image light ray propagating in the second propagation direction. As shown in FIG. 13, when a radius of an entrance pupil P23 of the third auxiliary light beam L23 in the second propagation direction is denoted by R3, the radius R3 is determined by the second dimension Rb in the direction corresponding to the second direction D2 of the entrance pupil P of the projection optical system 7. As one example, the radius R3 and the second dimension Rb satisfy a relation of R3=Rb/2.

The fourth auxiliary light beam L24 is the smallest in the propagation angle of light beams in the image light ray propagating in the second propagation direction. As shown in FIG. 14, when a radius of an entrance pupil P24 of the fourth auxiliary light beam L24 in the second propagation direction is denoted by R4, the radius R4 is determined by the second dimension Rb in the direction corresponding to the second direction D2 of the entrance pupil P of the projection optical system 7. As one example, the radius R4 and the second dimension Rb satisfy a relation of R4=Rb/2.

An angle between the third auxiliary light beam L23 and the fourth auxiliary light beam L24 corresponds to the second field of view angle FOV2 of the virtual image. In the present embodiment, the second field of view angle FOV2 is smaller than the first field of view angle FOV1. Therefore, the angle between the third auxiliary light beam L23 and the fourth auxiliary light beam L24 is smaller than the angle between the first auxiliary light beam L21 and the second auxiliary light beam L22. Therefore, a difference between a maximum value and a minimum value of the propagation angle in the image light ray propagating in the second propagation direction is smaller than a difference between a maximum value and a minimum value of the propagation angle in the image light ray propagating in the first propagation direction. Therefore, in the present embodiment, the image light ray propagating in the second propagation direction is less sensitive to the influence of the propagation angle.

Referring to FIG. 13, the third auxiliary light beam L23 is coupled to the light guide 4 by the in-coupling region 5, propagates inside the body 40 of the light guide 4 in the first propagation direction while being totally reflected by the first surface 40a and the second surface 40b of the body 40, and reaches the reproduction region 6. The third auxiliary light beam L23 is divided in the first propagation direction and directed in the second propagation direction by the dividing diffraction structure 61, and divided into a plurality of third auxiliary light beams L23a in the second propagation direction by the exit diffraction structure 62. The plurality of third auxiliary light beams L23a are made to emerge toward the field of view region 8 by the exit diffraction structure 62. In the field of view region 8, pupils P23a of image light rays by the plurality of third auxiliary light beams L23a are arranged in the second propagation direction.

When the propagation angle of the third auxiliary light beam L23 is denoted by θ3 and the thickness of the body 40 of the light guide 4 is denoted by t, an interval G23 between the adjacent pupils P23a is given by 2×t×tan θ3. An increase in the interval G23 relative to the entrance pupil P23 of the third auxiliary light beam L23 in the second propagation direction may result in an increase in the area of the field of view region 8 where no pupil P23a is located. A decrease in the interval G23 relative to the entrance pupil P23 of the third auxiliary light beam L23 in the second propagation direction may result in an increase in an area of the field of view region 8 where the pupils P23a overlap each other, which is wasteful. In view of this point, the optical system 3 is configured to allow the thickness t, the propagation angle θ3 and the radius R3 to satisfy a relation of 0.8<(t×tan θ3)/R3<1.5. Accordingly, it is possible to reduce the area of the field of view region 8 where no pupil P23a of the third auxiliary light beam L23 of the image light ray is located in the second propagation direction. In summary, it is possible to improve the filling factor of the pupil of the image light ray in the field of view region 8 in the second propagation direction. Further, it is possible to reduce an excess increase in an overlap area of the pupils P23a and reduce waste use of the image light ray.

Especially, in the present embodiment, the second field of view angle FOV2 is smaller than the first field of view angle FOV1 and therefore the propagation angle θ3 is smaller than the propagation angle θ1, and additionally, when a wave vector of the in-coupling region 5 is denoted by ka and a wave vector of the dividing diffraction structure 61 is denoted by kb, the wave vectors ka and kb satisfy a relation of |ka|>|ka+kb|. This may make the propagation angle θ3 be smaller than the propagation angle θ1. In the present embodiment, the second dimension Rb of the entrance pupil P is greater than the first dimension Ra of the entrance pupil P. Thus, the radii R3 and R4 are greater than the radii R1 and R2. As above, the optical system 3 may satisfy the relation of 1.6<(t×tan θ1)/R1<2.4 and the relation of 0.8<(t×tan θ3)/R3<1.2 both. Therefore, differently from the dividing diffraction structure 61, the exit diffraction structure 62 can reduce the area where no pupil of the image light ray is located, with the exit diffraction structure 62 including a diffraction grating at not both of the first surface 40a and the second surface 40b of the body 40 but either one thereof.

Referring to FIG. 14, the fourth auxiliary light beam L24 is coupled to the light guide 4 by the in-coupling region 5, propagates inside the body 40 of the light guide 4 in the first propagation direction while being totally reflected by the first surface 40a and the second surface 40b of the body 40, and reaches the reproduction region 6. The fourth auxiliary light beam L24 is divided in the first propagation direction and directed in the second propagation direction by the dividing diffraction structure 61, and divided into a plurality of fourth auxiliary light beams L24a in the second propagation direction by the exit diffraction structure 62. The plurality of fourth auxiliary light beams L24a are made to emerge toward the field of view region 8 by the exit diffraction structure 62. In the field of view region 8, pupils P24a of image light rays by the plurality of fourth auxiliary light beams L24a are arranged in the second propagation direction.

When the propagation angle of the fourth auxiliary light beam L24 is denoted by θ4 and the thickness of the body 40 of the light guide 4 is denoted by t, an interval G24 between the adjacent pupils P24a is given by t×tan θ4. It is supposed that the propagation angles θ3 and θ4 satisfy a relation of θ3>θ4 and the radii R3 and R4 are equal to each other. When the thickness t, the propagation angle θ3 and the radius R3 satisfy the relation of 0.8<(t×tan θ3)/R3<1.2, the thickness t, the propagation angle θ4 and the radius R4 satisfy a relation of 0.8<(t×tan θ4)/R4<1.2. Therefore, it is possible to reduce the area of the field of view region 8 where no pupil P24a is located.

In the second propagation direction, the in-coupling region 5 and the reproduction region 6 are not arranged side by side and therefore it is not expected that a pupil at a position where the third auxiliary light beam L23 or the fourth auxiliary light beam L24 is totally reflected by the first surface 40a at first time overlaps the in-coupling region 5. For this reason, there is no problem if the propagation angles θ3 and θ4 are relatively small. Improvement of the filling factor of the pupil of the image light ray is expected.

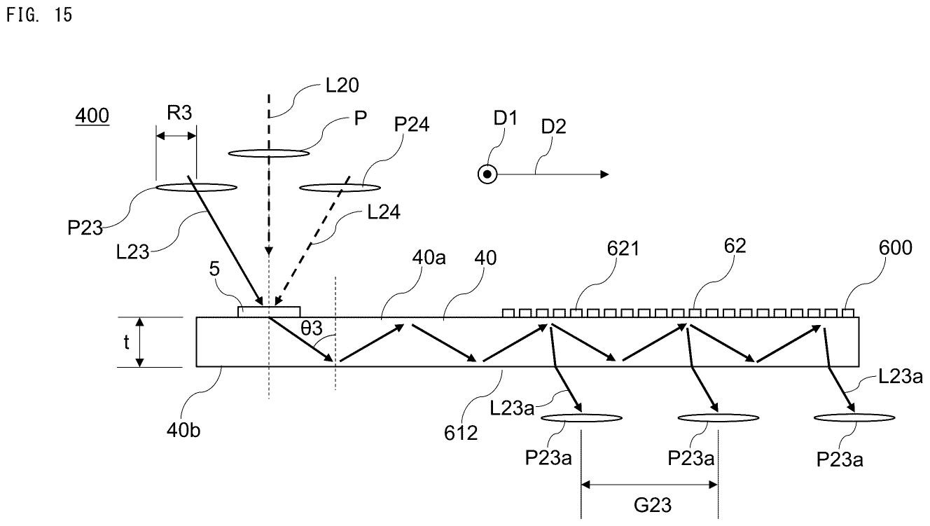

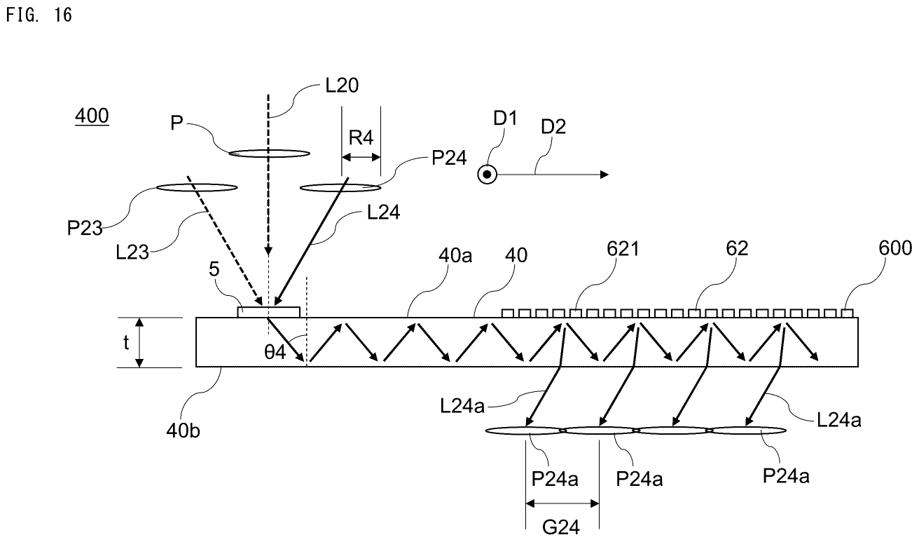

FIG. 15 is an explanatory view of a fifth example of propagation of the image light ray by the light guide 400 of the image display device according to the comparative example. FIG. 16 is an explanatory view of a sixth example of propagation of the image light ray by the light guide 400 of the image display device according to the comparative example. The fifth example and the sixth example of propagation of the image light ray by the light guide 400 of the image display device according to the comparative example relate to propagation of the image light ray in the first propagation direction.

In the comparative example of FIG. 15 and FIG. 16, the second field of view angle FOV2 is equal to the first field of view angle FOV1 and the propagation angles θ3 and θ4 are respectively equal to the propagation angles θ1 and θ2. In the comparative example of FIG. 15 and FIG. 16, the entrance pupil P of the projection optical system has a circle shape when viewed in the optical axis of the projection optical system, and the second dimension Rb of the entrance pupil P is equal to the first dimension Ra of the entrance pupil P. Therefore, the radii R3 and R4 are respectively equal to the radii R1 and R2.

Referring to FIG. 15, the third auxiliary light beam L23 is coupled to the light guide 400 by the in-coupling region 5, propagates inside the body 40 of the light guide 400 in the first propagation direction while being totally reflected by the first surface 40a and the second surface 40b of the body 40, and reaches the reproduction region 600. The third auxiliary light beam L23 is divided in the first propagation direction and directed in the second propagation direction by the dividing diffraction structure 61, and divided into a plurality of third auxiliary light beams L23a in the second propagation direction by the exit diffraction structure 62. The plurality of third auxiliary light beams L23a are made to emerge toward the field of view region 8 by the exit diffraction structure 62. In the field of view region 8, pupils P23a of image light rays by the plurality of third auxiliary light beams L23a are arranged in the second propagation direction.

Referring to FIG. 16, the fourth auxiliary light beam L24 is coupled to the light guide 400 by the in-coupling region 5, propagates inside the body 40 of the light guide 400 in the first propagation direction while being totally reflected by the first surface 40a and the second surface 40b of the body 40, and reaches the reproduction region 600. The fourth auxiliary light beam L24 is divided in the first propagation direction and directed in the second propagation direction by the dividing diffraction structure 61, and divided into a plurality of fourth auxiliary light beams L24a in the second propagation direction by the exit diffraction structure 62. The plurality of fourth auxiliary light beams L24a are made to emerge toward the field of view region 8 by the exit diffraction structure 62. In the field of view region 8, pupils P24a of image light rays by the plurality of fourth auxiliary light beams L24a are arranged in the second propagation direction.

The propagation angle θ4 of the fourth auxiliary light beam L24 is smaller than the propagation angle θ3 of the third auxiliary light beam L23. Therefore, a gap between the pupils 24a of the fourth auxiliary light beams L24 tends to be smaller, but a gap between the pupils 23a of the third auxiliary light beams L23 tends to be greater. In the comparative example of FIG. 15, the propagation angle θ3 is equal to the propagation angle θ1 and the radius R3 is equal to the radius R1 and therefore similarly to the case of FIG. 8, a relatively large gap is likely to occur between the pupils 23a and therefore the area of the field of view region 8 where no pupil P23a of the third auxiliary light beam L23 of the image light ray is located tends to increase. In this regard, as described above, by increasing the radius R3, it is expected that the area of the field of view region 8 where no pupil P23a of the third auxiliary light beam L23 of the image light ray is located can be reduced. However, to increase the radius R3, it is necessary to increase the entrance pupil P. In the comparative example of FIG. 15, the entrance pupil P has a circular shape when viewed in the optical axis of the projection optical system, an increase in the entrance pupil P results in increases in the radii R1, R2, and R4. Thus, as shown in FIG. 12, possibility that the main light beam L20 or the second auxiliary light beam L22 is extracted from the in-coupling region 5 may increase and a loss in the image light ray may increase.

Therefore, in FIG. 15, to reduce the area of the field of view region 8 where no pupil P23a of the third auxiliary light beam L23 of the image light ray is located, it is considered that, similarly to the dividing diffraction structure 61, the exit diffraction structure 62 is also configured to have a double-sided diffraction structure including diffraction gratings respectively formed at the first surface 40a and the second surface 40b of the body 40. However, this may cause an increase in production or manufacture cost. Especially, the area of the exit diffraction structure 62 tends to become larger than the area of the dividing diffraction structure 61. Therefore, additional manufacture cost for configuring the exit diffraction structure 62 to have a double-sided diffraction structure is likely to be greater than additional manufacture cost for configuring the dividing diffraction structure 61 to have a double-sided diffraction structure.

As described above, in the image display device 1, the second field of view angle FOV2 is smaller than the first field of view angle FOV1 and accordingly the propagation angle θ3 is smaller than the propagation angle θ1 and the second dimension Rb of the entrance pupil P is greater than the first dimension Ra of the entrance pupil P and accordingly the radius R3 is greater than the radius R1. Consequently, differently from the dividing diffraction structure 61, the exit diffraction structure 62 can reduce the area where no pupil of the image light ray is located, with the exit diffraction structure 62 including a diffraction grating at not both of the first surface 40a and the second surface 40b of the body 40 but either one thereof.

As described above, the image display device 1 enables reduction of the area where no pupil of the image light ray is located and improvement of the use efficiency of the image light ray. In the image display device 1, among the dividing diffraction structure 61 and the exit diffraction structure 62 of the reproduction region 6, only the dividing diffraction structure 61 has a double-sided diffraction structure including the first diffraction structure region 611 and the second diffraction structure region 612 respectively formed at the first surface 40a and the second surface 40b of the body 40, and the exit diffraction structure 62 has a one-sided diffraction structure including the third diffraction structure region 621 formed at the first surface 40a of the body 40. Therefore, in comparison to a whole of the reproduction region 6 having a double-sided diffraction structure, the manufacture cost of the image display device 1 can be reduced.

### 1.3 Advantageous Effects

As described above the optical system 3 includes the light guide 4 for guiding the image light ray L1 which is output from the display element 2 and forms the image, to the field of view region 8 of the user as the virtual image. The light guide 4 includes: the body 40 having the plate shape and including the first surface 40a and the second surface 40b in the thickness direction; the in-coupling region 5 formed at the body 40 and allowing the image light ray L1 to enter the body 40 so that the image light ray L1 propagates inside the body 40; and the reproduction region 6 formed at the body 40. The reproduction region 6 includes the dividing diffraction structure 61 dividing the image light ray L1, L11 propagating in the first propagation direction intersecting the thickness direction of the body 40 into the plurality of image light rays L1, L12 propagating in the second propagation direction intersecting the first propagation direction, in the first propagation direction and the exit diffraction structure 62 allowing the plurality of image light rays L1, L12 propagating in the second propagation direction to travel toward the field of view region 8. The dividing diffraction structure includes the first diffraction structure region 611 and the second diffraction structure region 612 which are formed respectively at the first surface 40a and the second surface 40b to face each other. The virtual image has the first direction D1 and the second direction D2 which are perpendicular to each other. When the first field of view angle in the first direction D1 of the virtual image is denoted by FOV1 and the second field of view angle in the second direction D2 of the virtual image is denoted by FOV2, the relation of FOV2/FOV1<0.5 is satisfied. The first propagation direction in the reproduction region 6 corresponds to the first direction D1 in the virtual image. This configuration can reduce the area of the field of view region 8 where no pupil of the image light ray L1 is located and improve the usage efficiency of the image light ray L1, and further can reduce the manufacture cost.

In the optical system 3, the first propagation direction and the second propagation direction intersect each other in the predetermined plane perpendicular to the thickness direction of the body 40. The second propagation direction in the reproduction region 6 corresponds to the second direction D2 in the virtual image. The exit diffraction structure 62 divides the plurality of image light rays L1, L12 propagating in the second propagation direction from the dividing diffraction structure 61 in the second propagation direction to allow them to emerge as the plurality of image light rays L1, L2 toward the field of view region 8. This configuration can reduce the area of the field of view region 8 where no pupil of the image light ray L1 is located and improve the usage efficiency of the image light ray L1, and further can reduce the manufacture cost.

In the optical system 3, the exit diffraction structure 62 includes the third diffraction structure region 621. The third diffraction structure region 621 is formed at any one of the first surface 40a and the second surface 40b and has periodicity in the second propagation direction. This configuration can reduce the area of the field of view region 8 where no pupil of the image light ray L1 is located and improve the usage efficiency of the image light ray L1, and further can reduce the manufacture cost.

In the optical system 3, the in-coupling region 5 allows the image light ray L1 to enter the body 40 so that the image light ray L1 propagates in the first propagation direction inside the body 40. When the wave vector of the in-coupling region 5 is denoted by ka, and the wave vector of the dividing diffraction structure 61 is denoted by kb, the wave vectors ka and kb satisfy the relation of |ka|>|ka+kb|. This configuration can reduce the area of the field of view region 8 where no pupil of the image light ray L1 is located and improve the usage efficiency of the image light ray L1, and further can reduce the manufacture cost.

In the optical system 3, the optical system 3 further includes the projection optical system 7 allowing the image light ray L1 from the display element 2 to be incident on the in-coupling region 5 of the light guide 4. The first dimension in the direction corresponding to the first direction D1 of the entrance pupil P of the projection optical system 7 is smaller than the second dimension in the direction corresponding to the second direction D2 of the entrance pupil P of the projection optical system 7. This configuration can reduce the area of the field of view region 8 where no pupil of the image light ray L1 is located and improve the usage efficiency of the image light ray L1, and further can reduce the manufacture cost.

In the optical system 3, when the first dimension is denoted by Ra and the second dimension is denoted by Rb, the relation of 0.3<Ra/Rb<0.7 is satisfied. This configuration can reduce the area of the field of view region 8 where no pupil of the image light ray L1 is located and improve the usage efficiency of the image light ray L1, and further can reduce the manufacture cost.

In the optical system 3, when the thickness of the body 40 is denoted by t, the propagation angle of the first light beam (first auxiliary light beam L21) which is the largest in the propagation angle in the image light ray propagating in the first propagation direction is denoted by θ1, and the radius of the entrance pupil P22 of the first light beam (first auxiliary light beam L21) in the first propagation direction is denoted by R1, the relation of 1.6<(t×tan θ1)/R1<2.4 is satisfied. This configuration can reduce the area of the field of view region 8 where no pupil of the image light ray L1 is located and improve the usage efficiency of the image light ray L1, and further can reduce the manufacture cost.

In the optical system 3, when the thickness of the body 40 is denoted by t, the propagation angle of the second light beam (second auxiliary light beam L22) which is the smallest in the propagation angle in the image light ray propagating in the first propagation direction is denoted by θ2, the radius of the entrance pupil P22 of the second light beam (second auxiliary light beam L22) in the first propagation direction is denoted by R2, and the half value of the dimension in the first propagation direction of the in-coupling region 5 is denoted by d0, the relation of 0.7<(2×t×tan θ2)/(R2+d0)<1.5 is satisfied. This configuration can reduce the area of the field of view region 8 where no pupil of the image light ray L1 is located and improve the usage efficiency of the image light ray L1, and further can reduce the manufacture cost.

The aforementioned optical system 3 includes the light guide 4 for guiding the image light ray L1 which is output from the display element 2 and forms the image, to the field of view region 8 of the user as the virtual image. The light guide 4 includes: the body 40 having the plate shape and including the first surface 40a and the second surface 40b in the thickness direction; the in-coupling region 5 formed at the body 40 and allowing the image light ray L1 to enter the body 40 so that the image light ray L1 propagates inside the body 40; and the reproduction region 6 formed at the body 40. The reproduction region 6 includes the dividing diffraction structure 61 dividing the image light ray L1, L11 propagating in the first propagation direction intersecting the thickness direction of the body 40 into the plurality of image light rays L1, L12 propagating in the second propagation direction intersecting the first propagation direction, in the first propagation direction and the exit diffraction structure 62 allowing the plurality of image light rays L1, L12 propagating in the second propagation direction to travel toward the field of view region 8. The dividing diffraction structure 61 includes the first diffraction structure region 611 and the second diffraction structure region 612 which are respectively formed at the first surface 40a and the second surface 40b to face each other. The entrance pupil P of the projection optical system 7 has the first direction D1 and the second direction D2 which are perpendicular to each other. The first dimension in the first direction D1 of the entrance pupil P is smaller than the second dimension in the second direction D2 of the entrance pupil P. The first propagation direction in the reproduction region 6 corresponds to the first direction D1 in the entrance pupil P. This configuration can reduce the area of the field of view region 8 where no pupil of the image light ray L1 is located and improve the usage efficiency of the image light ray L1, and further can reduce the manufacture cost.

The aforementioned optical system 3 includes the light guide 4 for guiding the image light ray L1 which is output from the display element 2 and forms the image, to the field of view region 8 of the user as the virtual image. The light guide 4 includes: the body 40 having the plate shape and including the first surface 40a and the second surface 40b in the thickness direction; the in-coupling region 5 formed at the body 40 and allowing the image light ray L1 to enter the body 40 so that the image light ray L1 propagates inside the body 40; and the reproduction region 6 formed at the body 40. The reproduction region 6 includes the dividing diffraction structure 61 dividing the image light ray L1, L11 propagating in the first propagation direction intersecting the thickness direction of the body 40 into the plurality of image light rays L1, L12 propagating in the second propagation direction intersecting the first propagation direction, in the first propagation direction and the exit diffraction structure 62 allowing the plurality of image light rays L1, L12 propagating in the second propagation direction to travel toward the field of view region 8. The dividing diffraction structure 61 includes the first diffraction structure region 611 and the second diffraction structure region 612 which are respectively formed at the first surface 40a and the second surface 40b to face each other. When the thickness of the body 40 is denoted by t, the propagation angle of the first light beam (first auxiliary light beam L21) which is the largest in the propagation angle in the image light ray propagating in the first propagation direction is denoted by θ1, and the radius of the entrance pupil P22 of the first light beam (first auxiliary light beam L21) in the first propagation direction is denoted by R1, the relation of 1.6<(t×tan θ1)/R1<2.4 is satisfied. When the propagation angle of the second light beam (second auxiliary light beam L22) which is the smallest in the propagation angle in the image light ray propagating in the first propagation direction is denoted by θ2, the radius of the entrance pupil P22 of the second light beam (second auxiliary light beam L22) in the first propagation direction is denoted by R2, and the half value of the dimension in the first propagation direction of the in-coupling region 5 is denoted by d0, the relation of 0.7<(2×t×tan θ2)/(R2+d0)<1.5 is satisfied. This configuration can reduce the area of the field of view region 8 where no pupil of the image light ray L1 is located and improve the usage efficiency of the image light ray L1, and further can reduce the manufacture cost.

The aforementioned image display device 1 includes the optical system 3 and the display element 2. This configuration can reduce the area of the field of view region 8 where no pupil of the image light ray L1 is located and improve the usage efficiency of the image light ray L1, and further can reduce the manufacture cost.

### 2. VARIATIONS

Embodiments of the present disclosure are not limited to the above embodiment. The above embodiment may be modified in various ways in accordance with designs or the like to an extent that they can achieve the problem of the present disclosure. Hereinafter, some variations or modifications of the above embodiment will be listed. One or more of the variations or modifications described below may apply in combination with one or more of the others.

### 2.1 Variation 1

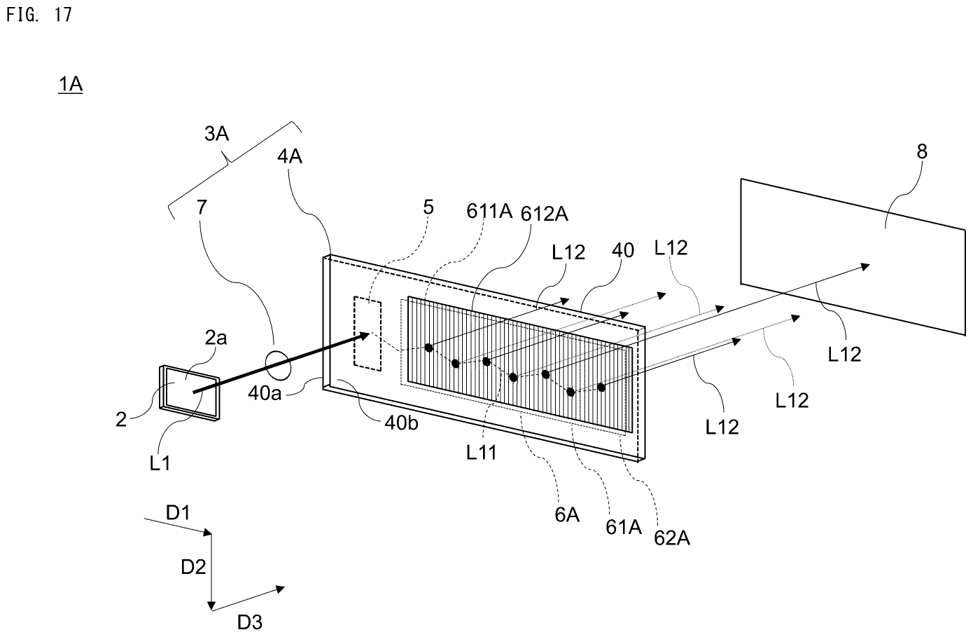

FIG. 17 is a schematic perspective view of a configuration example of an image display device 1A according to variation 1. The image display device 1A is a head mounted display (HMD) which is mounted on a user's head and displays an image (picture), for example. The image display device 1A includes the display element 2 and an optical system 3A.

As shown in FIG. 17, the optical system 3A is configured to guide the image light ray L1 output from the display element 2 to the field of view region 8 set relative to eyes of the user. Within the field of view region 8, the user can watch by his or her own eyes the image formed by the display element 2 with the image not being interrupted. Especially, in the present variation, the optical system 3A expands the field of view region 8 by utilizing effects of pupil expansion.

As shown in FIG. 17, the optical system 3A includes a light guide 4A and the projection optical system 7. The light guide 4A is configured to guide the image light ray L1 which is output from the display element 2 and forms the image, toward the field of view region 8 of the user as the virtual image. The light guide 4A includes the body 40, the in-coupling region 5, and a reproduction region 6A.

The reproduction region 6A is formed at the body 40. The reproduction region 6A divides the image light ray L11 propagating in the first propagation direction intersecting the thickness direction of the body 40, into the plurality of image light rays L12 arranged in the first propagation direction and propagating in the second propagation direction intersecting the first propagation direction.

In the reproduction region 6A,

the first propagation direction is a direction corresponding to the first direction D1. In the present variation, the first propagation direction is parallel to the first direction D1. The second propagation direction is not a direction corresponding to the second direction D2 but corresponds to a direction from the light guide 4A toward the field of view region 8. The direction from the light guide 4A toward the field of view region 8 corresponds to a direction D3 of the optical axis of the display element 2. In the present variation, the second propagation direction is parallel to the direction D3 of the optical axis of the display element 2.

Therefore, the reproduction region 6A divides the image light ray L11 into the plurality of image light rays L12 in the first propagation direction and allows them to emerge toward the field of view region 8.

As shown in FIG. 17, the reproduction region 6A includes a first diffraction structure region 611A and a second diffraction structure region 612A. In the present variation, the first diffraction structure region 611A and the second diffraction structure region 612A constitute a dividing diffraction structure 61A configured to divide the image light ray L1, L11 propagating in the first propagation direction intersecting the thickness direction of the body 40 into the plurality of image light rays L1, L12 propagating in the second propagation direction intersecting the first propagation direction, in the first propagation direction. Further, the dividing diffraction structure 61A functions as an exit diffraction structure 62A configured to allow the plurality of image light rays L1, L12 propagating in the second propagation direction to travel toward the field of view region 8. In summary, in the present variation, the first diffraction structure region 611A and the second diffraction structure region 612A constitute the dividing diffraction structure 61A as well as the exit diffraction structure 62A.

The first diffraction structure region 611A and the second diffraction structure region 612A are formed respectively at the first surface 40a and the second surface 40b of the body 40 to face each other. The first diffraction structure region 611A and the second diffraction structure region 612A are arranged side by side with the in-coupling region 5 in the first propagation direction.

Each of the first diffraction structure region 611A and the second diffraction structure region 612A is a surface-relief diffraction grating. Each of the first diffraction structure region 611A and the second diffraction structure region 612A has recessed or protruded parts arranged periodically. The first diffraction structure region 611A is a reflection diffraction grating. The second diffraction structure region 612A is a transmission diffraction grating. Each of the first diffraction structure region 611A and the second diffraction structure region 612A is configured to divide a light ray propagating in the first propagation direction intersecting the thickness direction of the body 40 (the image light ray L11), into a plurality of light rays propagating in the second propagation direction intersecting the first propagation direction (the image light ray L12), in the first propagation direction. The first diffraction structure region 611A and the second diffraction structure region 612A allow the plurality of image light rays L12 arranged in the first propagation direction to travel toward the field of view region 8, by dividing the image light ray L11 propagating inside the body 40 of the light guide 4A. By doing so, the reproduction region 6A realizes pupil expansion of the image light ray L1 in the first propagation direction. In FIG. 17, the image light rays L12 divided from the image light ray L11 by the first diffraction structure region 611A are represented by dotted lines, and the image light rays L12 divided from the image light ray L11 by the second diffraction structure region 612A are represented by solid lines.

As one example, each of the first diffraction structure region 611A and the second diffraction structure region 612A is constituted by plurality of recessed or protruded parts in relation to the thickness direction of the body 40 which are arranged to have periodicity in a periodic direction. The periodic direction is a direction where the recessed or protruded parts are arranged to have periodicity. The periodic direction includes a component of the first propagation direction. To convert the image light ray L11 propagating in the first propagation direction into the image light rays L12 propagating in the second propagation direction, the periodic direction is set to be the first propagation direction. In this case, the periodic direction includes the component of the first propagation direction only. The periodic direction of the first diffraction structure region 611 or the second diffraction structure region 612 is a direction of a wave vector thereof. As one example, the recessed or protruded parts of the first diffraction structure region 611A are arranged in the first propagation direction in a plane perpendicular to the thickness direction of the body 40. Thus, the image light ray L11 propagating in the first propagation direction is converted into the image light ray L12 propagating in the second propagation direction.

Sizes of the first diffraction structure region 611A and the second diffraction structure region 612A are set to allow a whole of the image light ray L11 from the in-coupling region 5 to enter the first diffraction structure region 611A and the second diffraction structure region 612A. In the present variation, each of the first diffraction structure region 611A and the second diffraction structure region 612A has a quadrilateral shape.

In the image display device 1A of FIG. 17, since the reproduction region 6A of the light guide 4A has a double-sided diffraction structure including the first diffraction structure region 611A and the second diffraction structure region 612A formed respectively at the first surface 40a and the second surface 40b of the body 40, it is possible to reduce the area of the field of view region 8 where no pupil of the image light ray is located in the first propagation direction. Further, the image display device 1A does not require an increase in the entrance pupil P of the projection optical system 7 and thus enables reduction of probability that part of the image light ray is extracted from the in-coupling region 5. In summary, it is possible to improve the use efficiency of the image light ray in the first propagation direction.

The aforementioned optical system 3A includes the light guide 4A for guiding the image light ray L1 which is output from the display element 2 and forms the image, to the field of view region 8 of the user as the virtual image. The light guide 4A includes: the body 40 having the plate shape and including the first surface 40a and the second surface 40b in the thickness direction; the in-coupling region 5 formed at the body 40 and allowing the image light ray L1 to enter the body 40 so that the image light ray L1 propagates inside the body 40; and the reproduction region 6A formed at the body 40. The reproduction region 6A includes the dividing diffraction structure 61A dividing the image light ray L1, L11 propagating in the first propagation direction intersecting the thickness direction of the body 40 into the plurality of image light rays L1, L12 propagating in the second propagation direction intersecting the first propagation direction, in the first propagation direction and the exit diffraction structure 62A allowing the plurality of image light rays L1, L12 propagating in the second propagation direction to travel toward the field of view region 8. The dividing diffraction structure 61A includes the first diffraction structure region 611A and the second diffraction structure region 612A which are respectively formed at the first surface 40a and the second surface 40b to face each other. The virtual image has the first direction D1 and the second direction D2 which are perpendicular to each other. When the first field of view angle in the first direction D1 of the virtual image is denoted by FOV1 and the second field of view angle in the second direction D2 of the virtual image is denoted by FOV2, a relation of FOV2/FOV1<0.5 is satisfied. The first propagation direction in the reproduction region 6A corresponds to the first direction D1 in the virtual image. This configuration can reduce the area of the field of view region 8 where no pupil of the image light ray L1 is located and improve the usage efficiency of the image light ray L1, and further can reduce the manufacture cost.

In the optical system 3A, the dividing diffraction structure 61A functions as the exit diffraction structure 62A. The second propagation direction in the reproduction region 6 corresponds to the direction from the light guide 4A toward the field of view region 8. This configuration can reduce the area of the field of view region 8 where no pupil of the image light ray L1 is located and improve the usage efficiency of the image light ray L1, and further can reduce the manufacture cost.

### 2.2 Variation 2

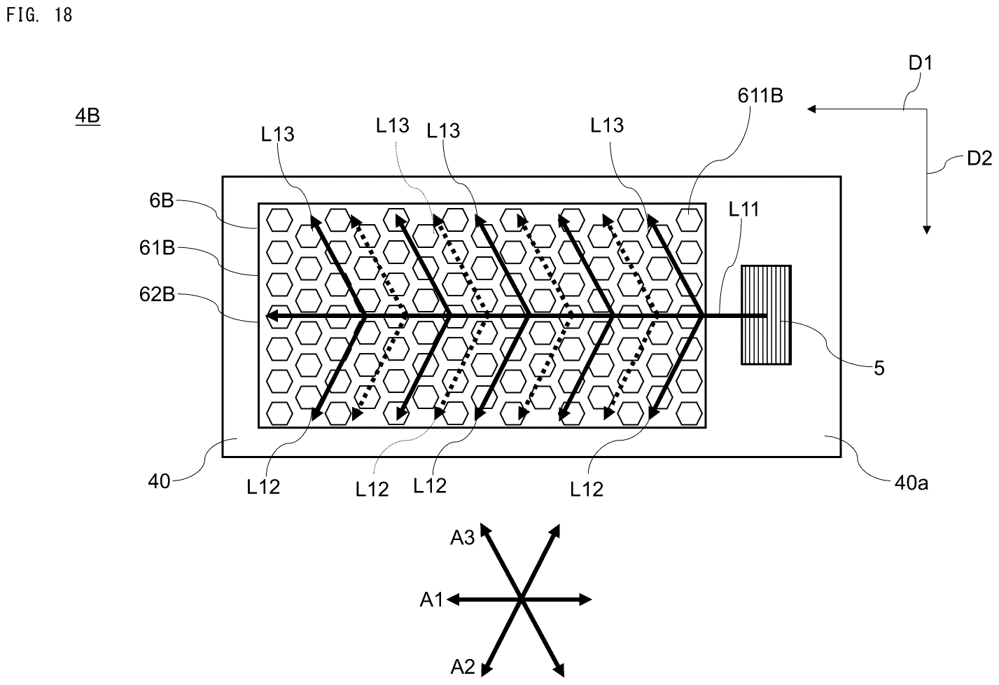

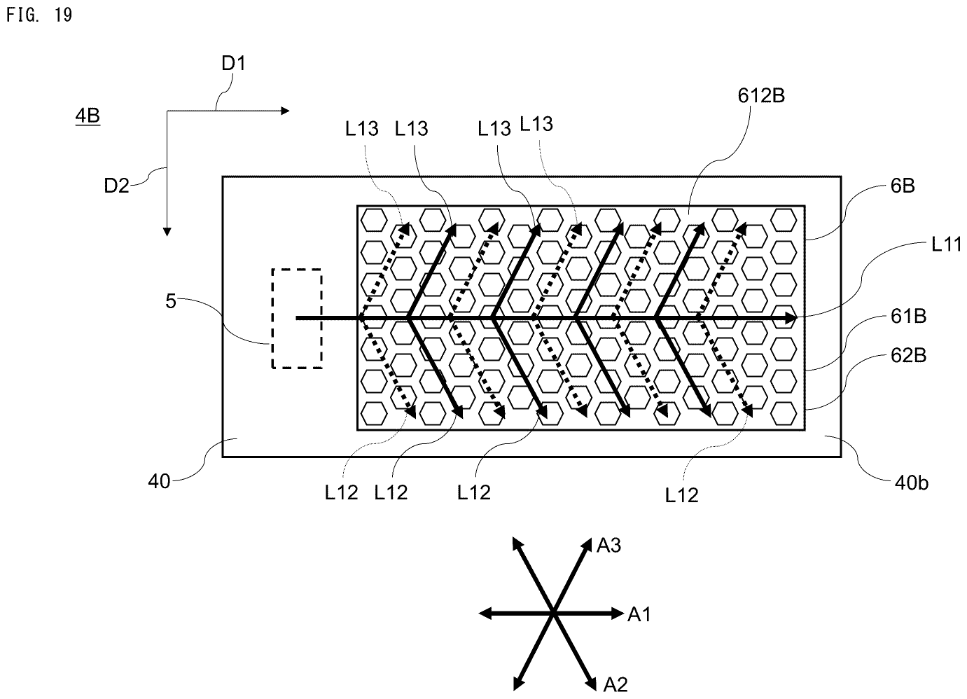

FIG. 18 and FIG. 19 are schematic plan views of a light guide 4B according to variation 2. Especially, FIG. 18 is a schematic plan view of the light guide 4B when viewed from the display element 2 and FIG. 19 is a schematic plan view of the light guide 4B when viewed from the field of view region 8.

The light guide 4B of FIG. 18 and FIG. 19 includes the body 40, the in-coupling region 5, and a reproduction region 6B.

The reproduction region 6B is formed at the body 40. The reproduction region 6B divides the image light ray L1 propagating in the first propagation direction intersecting the thickness direction of the body 40, into a plurality of image light rays L1 arranged in the first propagation direction and propagating in the second propagation direction intersecting the first propagation direction and a plurality of image light rays L1 propagating in a third propagation direction intersecting the first propagation direction. Hereinafter, for the purpose of simplifying the description only, to distinguish the image light ray L1 incident on the light guide 4 from other image light rays L1, the image light ray L1 propagating in the first propagation direction inside the body 40 may be denoted by an image light ray L11, the image light ray L1 propagating in the second propagation direction inside the body 40 may be denoted by an image light ray L12, and the image light ray L1 propagating in the third propagation direction inside the body 40 may be denoted by an image light ray L13.

The reproduction region 6B includes a first diffraction structure region 611B shown in FIG. 18 and a second diffraction structure region 612B shown in FIG. 19. In the present variation, the first diffraction structure region 611A and the second diffraction structure region 612A constitute a dividing diffraction structure 61B configured to divide the image light ray L1 (L11) propagating in the first propagation direction intersecting the thickness direction of the body 40, into the plurality of image light rays L1 (L12) propagating in the second propagation direction intersecting the first propagation direction, in the first propagation direction. Further, the dividing diffraction structure 61B functions as an exit diffraction structure 62B configured to allow the plurality of image light rays L1 (L12) propagating in the second propagation direction to travel toward the field of view region 8. In summary, in the present variation, the first diffraction structure region 611B and the second diffraction structure region 612B constitute the dividing diffraction structure 61B as well as the exit diffraction structure 62.

The first diffraction structure region 611B and the second diffraction structure region 612B are formed respectively at the first surface 40a and the second surface 40b of the body 40 to face each other.

Each of the first diffraction structure region 611B and the second diffraction structure region 612B is a two-dimensional diffraction grating having periodicity in a plurality of different directions. Each of the first diffraction structure region 611B of FIG. 18 and the second diffraction structure region 612B of FIG. 19 has periodicity in two or more predetermined directions A1, A2, A3 so as to divide the image light ray L1 incident from the in-coupling region 5 in a plurality of branch directions including two or more branch directions respectively parallel to the two or more predetermined directions A1, A2, A3, allow a plurality of image light rays L1 (image light rays L11, L12, L13) to propagate inside the body 40, and allow the plurality of image light rays L1 (image light rays L11, L12, L13) propagating in the plurality of branch directions inside the body 40 to emerge from the body 40 toward the field of view region 8. The plurality of branch directions intersect each other in the predetermined plane perpendicular to the thickness direction of the body 40 and includes the first propagation direction and the second propagation direction.

In the reproduction region 6B of FIG. 18 and FIG. 19, each of the first diffraction structure region 611B and the second diffraction structure region 612B divides the image light ray L11 propagating in the first propagation direction, into the plurality of image light rays L12 propagating in the second propagation direction and the plurality of image light rays L13 propagating in the third propagation direction, in the first propagation direction, and allows the image light rays L11, L12, L13 to emerge from the body 40 toward the field of view region 8. In FIG. 18, the image light rays L12, L13 divided from the image light ray L11 by the first diffraction structure region 611B are represented by solid lines, and the image light rays L12, L13 divided from the image light ray L11 by the second diffraction structure region 612B are represented by dotted lines. In FIG. 19, the image light rays L12, L13 divided from the image light ray L11 by the first diffraction structure region 611B are represented by dotted lines, and the image light rays L12, L13 divided from the image light ray L11 by the second diffraction structure region 612B are represented by solid lines.

In detail, the first diffraction structure region 611B of FIG. 18 is a rectangular region formed at the first surface 40a of the body 40. The first diffraction structure region 611B has periodicity in the three predetermined directions A1, A2, and A3 intersecting each other in the predetermined plane perpendicular to the thickness direction of the body 40. In FIG. 18, the three predetermined directions A1, A2, and A3 are not perpendicular to each other. Respective periods of the first diffraction structure region 611B in the three predetermined directions A1, A2, and A3 are constant and equal to each other. In FIG. 18, the predetermined direction the predetermined direction A1 corresponds to the length direction of the body 40. Based on a counterclockwise direction of FIG. 18 (i.e., a counterclockwise direction when the light guide 4B is viewed from the display element 2), the predetermined direction A2 intersects the predetermined direction A1 at a predetermined angle (e.g., 60 degrees) and the predetermined direction A3 intersects the predetermined direction A1 at a predetermined angle (e.g., 120 degrees).

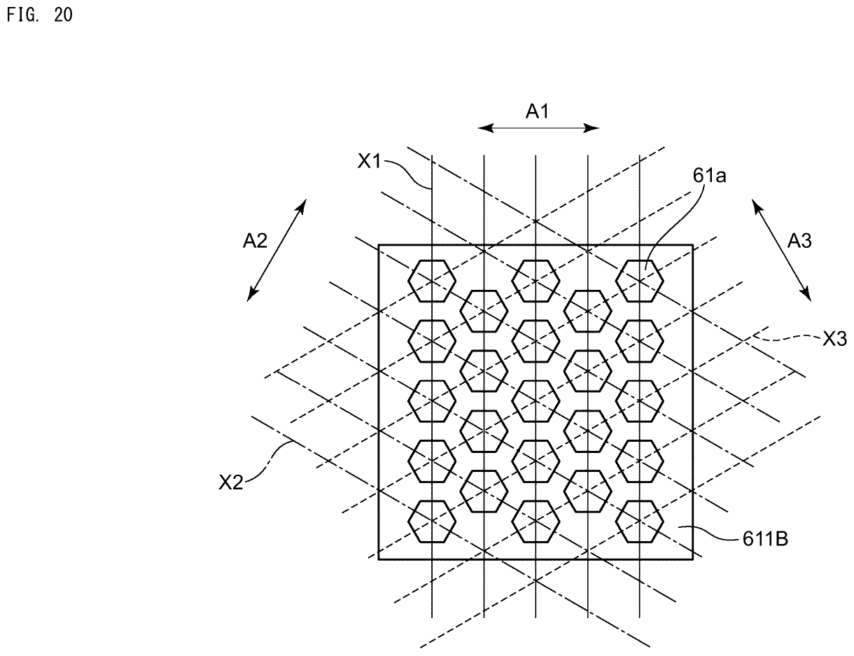

FIG. 20 is a plan view of a configuration example of the first diffraction structure region 611B of the reproduction region 6B of the light guide 4B. The first diffraction structure region 611B is constituted by recessed or protruded parts61a in relation to the thickness direction of the body 40 which are arranged in the predetermined plane to have periodicity in the three predetermined directions A1, A2, and A3.

In detail, as shown in FIG. 20, in the first diffraction structure region 611B, the recessed or protruded parts 41a are arranged to satisfy following conditions (1) to (3). The condition (1) specifies that in the predetermined direction A1, rows of the recessed or protruded parts 61a arranged in a direction X1 perpendicular to the predetermined direction A1 are arranged at a regular interval. Satisfying the condition (1) allows the first diffraction structure region 611B to function as a diffraction grating for diffracting light into the predetermined direction A1. The condition (2) specifies that in the predetermined direction A2, rows of the recessed or protruded parts 61a arranged in a direction X2 perpendicular to the predetermined direction A2 are arranged at a regular interval. Satisfying the condition (2) allows the first diffraction structure region 611B to function as a diffraction grating for diffracting light into the predetermined direction A2. The condition (3) specifies that in the predetermined direction A3, rows of the recessed or protruded parts 61a arranged in a direction X3 perpendicular to the predetermined direction A3 are arranged at a regular interval. Satisfying the condition (3) allows the first diffraction structure region 611B to function as a diffraction grating for diffracting light into the predetermined direction A3.

In FIG. 20, the recessed or protruded parts 61a are arranged in a hexagonal lattice, thereby satisfying the conditions (1) to (3). In FIG. 20, each recessed or protruded part 61a is a protrusion with a hexagonal shape in its plan view. Note that, shapes of the recessed or protruded parts 61a are not limited in particular. The recessed or protruded part 61a may be a protrusion (protruded part) protruding in the thickness direction of the body 40, or a recessed part recessed in the thickness direction of the body 40. The recessed or protruded part 61a may have circular, polygonal, or other shapes in its plan view. If the recessed or protruded parts 61a can constitute a diffraction structure, they may be any of a group of protrusions (protruded parts), a group of recessed parts, or a combination of protruded parts and recessed parts.

Similarly to the first diffraction structure region 611B, also the second diffraction structure region 612B is constituted by recessed or protruded parts 61a in relation to the thickness direction of the body 40 which are arranged in the predetermined plane to have periodicity in the three predetermined directions A1, A2, and A3.

The reproduction region 6B of the aforementioned the light guide 4B has a double-sided diffraction structure including the first diffraction structure region 611B and the second diffraction structure region 612B formed respectively at the first surface 40a and the second surface 40b of the body 40 and therefore it is possible to reduce the area of the field of view region 8 where no pupil of the image light ray is located, in the plurality of branch directions including the first propagation direction and the second propagation direction. Further, the image display device 1A does not require an increase in the entrance pupil P of the projection optical system 7 and thus enables reduction of probability that part of the image light ray is extracted from the in-coupling region 5. In summary, it is possible to improve the use efficiency of the image light ray in the plurality of branch directions.

The aforementioned optical system 3B includes the light guide 4B for guiding the image light ray L1 which is output from the display element 2 and forms the image, to the field of view region 8 of the user as the virtual image. The light guide 4B includes: the body 40 having the plate shape and including the first surface 40a and the second surface 40b in the thickness direction; the in-coupling region 5 formed at the body 40 and allowing the image light ray L1 to enter the body 40 so that the image light ray L1 propagates inside the body 40; and the reproduction region 6B formed at the body 40. The reproduction region 6B includes the dividing diffraction structure 61B dividing the image light ray L1, L11 propagating in the first propagation direction intersecting the thickness direction of the body 40 into the plurality of image light rays L1, L12 propagating in the second propagation direction intersecting the first propagation direction, in the first propagation direction and the exit diffraction structure 62B allowing the plurality of image light rays L1, L12 propagating in the second propagation direction to travel toward the field of view region 8. The dividing diffraction structure 61B includes the first diffraction structure region 611B and the second diffraction structure region 612B which are respectively formed at the first surface 40a and the second surface 40b to face each other. The virtual image has the first direction D1 and the second direction D2 which are perpendicular to each other. When the first field of view angle in the first direction D1 of the virtual image is denoted by FOV1 and the second field of view angle in the second direction D2 of the virtual image is denoted by FOV2, a relation of FOV2/FOV1<0.5 is satisfied. The first propagation direction in the reproduction region 6B corresponds to the first direction D1 in the virtual image. This configuration can reduce the area of the field of view region 8 where no pupil of the image light ray L1 is located and improve the usage efficiency of the image light ray L1, and further can reduce the manufacture cost.

In the optical system 3B, the dividing diffraction structure 61B functions as the exit diffraction structure 62B. Each of the first diffraction structure region 611B and the second diffraction structure region 612B has periodicity in two or more predetermined directions A1, A2, A3 so as to divide the image light ray L1 incident from the in-coupling region 5 in the plurality of branch directions including two or more branch directions respectively parallel to the two or more predetermined directions A1, A2, A3, allow the plurality of image light rays L! to propagate inside the body 40, and allow the plurality of image light rays L1 propagating in the plurality of branch directions inside the body 40 to emerge from the body 40 toward the field of view region 8. The plurality of branch directions intersect each other in the predetermined plane perpendicular to the thickness direction of the body 40 and include the first propagation direction and the second propagation direction. This configuration can reduce the area of the field of view region 8 where no pupil of the image light ray L1 is located and improve the usage efficiency of the image light ray L1, and further can reduce the manufacture cost.

### 2.3 Other Variations

In one variation, it is not always necessary that the light guide 4, 4A, 4B and the field of view region 8 are arranged in a straight line. In other words, the optical path from the light guide 4, 4A, 4B to the field of view region 8 always need not be straight. For example, a light ray from the light guide 4, 4A, 4B may be reflected by a reflector, a combiner, a window shield, or the like, to be incident on the field of view region 8. In this arrangement, the optical path from the light guide 4, 4A, 4B to the field of view region 8 is not straight but an L-shape, for example.

In one variation, the shape and dimensions of the light guide 4, 4A, 4B may be set to allow a user to visually perceive the virtual image even when the length of the optical path from the light guide 4, 4A, 4B to the field of view region 8 is equal to or longer than 300 mm. This arrangement allows the optical system 3 to apply to a head-up display (HUD) which is longer in a distance between a user and the optical system 3, 3A than HMD.

In one variation, in the light guide 4, it is not necessary that the wave vectors ka and kb satisfy the relation of |ka|>|ka+kb|.

In one variation, the in-coupling region 5 is not limited to a surface-relief diffraction grating, but may include a volume holographic element (holographic diffraction grating) or a half mirror. In one variation, the in-coupling region 5 may not be always provided to the first surface 40a or the second surface 40b of the body 40. The in-coupling region 5 may be formed at a side surface (edge surface) of the body 40. For example, the in-coupling region 5 may be constituted by a surface inclined relative to the thickness direction of the body 40. Thus, the in-coupling region 5 can guide the image light ray L1 into the body 40 and allow it to travel inside the body 40 toward the reproduction region 6, 6A, 6B. In this case, the in-coupling region 5 may not be always constituted by a diffraction structure causing diffraction effect for the image light ray L1, but may be constituted by a surface for refracting the image light ray L1 toward the reproduction region 6, 6A, 6B.

In one variation, the first diffraction structure region 611, 611A, 611B, the second diffraction structure region 612, 612A, 612B and the third diffraction structure region 621 each may not be limited to a surface-relief diffraction grating, but may be a volume holographic element (holographic diffraction grating).

In one variation, the exit diffraction structure 62 may not be limited to a surface-relief diffraction grating, but may include a volume holographic element (holographic diffraction grating) or a half mirror. Especially, in the reproduction region 6, it is sufficient that the exit diffraction structure 62 is configured to allow the plurality of image light rays L1, L12 propagating in the second propagation direction to travel toward the field of view region 8. The exit diffraction structure 62 may not always include a function of dividing the plurality of image light rays L1, L12 propagating in the second propagation direction in the second propagation direction.

In one variation, the projection optical system 7 may be a single optical element. The projection optical system 7 may be a biconvex lens allowing the image light ray L1 to be incident on the in-coupling region 5 as a substantial collimate light ray.

In one variation, if the first dimension in the direction corresponding to the first direction D1 of the entrance pupil P of the projection optical system 7 is smaller than the second dimension in the direction corresponding to the second direction D2 of the entrance pupil P of the projection optical system 7, the first field of view angle in the first direction D1 of the virtual image may not be always greater than the second field of view angle in the second direction D2 of the virtual image.

In one variation, it may be sufficient that at least one of the relation of 1.6<(t×tan θ1)/R1<2.4 or the relation of 0.7<(2×t×tan θ2)/(R2+d0)<1.5. In this case, the first dimension in the direction corresponding to the first direction D1 of the entrance pupil P of the projection optical system 7 may not always be smaller than the second dimension in the direction corresponding to the second direction D2 of the entrance pupil P of the projection optical system 7, and the first field of view angle in the first direction D1 of the virtual image may not be always greater than the second field of view angle in the second direction D2 of the virtual image.

In one variation, it is not always necessary that the projection optical system 7 and the in-coupling region 5 are arranged in a straight line. In other words, the optical path of the image light ray L1 from the projection optical system 7 toward the in-coupling region 5 always need not be straight. For example, the image light ray L1 from the projection optical system 7 may be reflected by a reflection plate to be incident on the in-coupling region 5. In this arrangement, the optical path of the image light ray L1 from the projection optical system 7 toward the in-coupling region 5 is not straight but an L-shape, for example.

In one variation, the image display device 1 may include a plurality of light guides 4, 4A, 4B respectively corresponding to wavelengths of light rays included in the image light ray L1. This can reduce influence resulting from chromatic aberration of light rays included in the image light ray L1.

### 3. ASPECTS

As apparent from the above embodiment and variations, the present disclosure includes the following aspects. Hereinafter, reference signs in parenthesis are attached for the purpose of clearly showing correspondence with the embodiments only.

A first aspect is an optical system (3; 3A) comprising: a light guide (4; 4A; 4B) for guiding an image light ray (L1) which is output from a display element (2) and forms an image, to a field of view region (8) of a user as a virtual image. The light guide (4; 4A; 4B) includes: a body (40) having a plate shape and including a first surface (40a) and a second surface (40b) in a thickness direction; an in-coupling region (5) formed at the body (40) and allowing the image light ray (L1) to enter the body (40) so that the image light ray (L1) propagates inside the body (40); and a reproduction region (6; 6A; 6B) formed at the body (40). The reproduction region (6; 6A; 6B) includes: a dividing diffraction structure (61; 61A; 61B) dividing an image light ray (L1, L11) propagating in a first propagation direction intersecting the thickness direction of the body (40) into a plurality of image light rays (L1, L12) propagating in a second propagation direction intersecting the first propagation direction, in the first propagation direction; and an exit diffraction structure (62; 62A; 62B) allowing the plurality of image light rays (L1, L12) propagating in the second propagation direction to travel toward the field of view region (8). The dividing diffraction structure (61; 61A; 61B) includes a first diffraction structure region (611; 611A; 611B) and a second diffraction structure region (612; 612A; 612B) which are formed respectively at the first surface (40a) and the second surface (40b) to face each other. The virtual image has a first direction (D1) and a second direction (D2) which are perpendicular to each other. When a first field of view angle in the first direction (D1) of the virtual image is denoted by FOV1 and a second field of view angle in the second direction (D2) of the virtual image is denoted by FOV2, a relation of FOV2/FOV1<0.5 is satisfied. The first propagation direction in the reproduction region (6; 6A; 6B) corresponds to the first direction (D1) in the virtual image. This aspect can reduce the area of the field of view region (8) where no pupil of the image light ray (L1) is located and improve the usage efficiency of the image light ray (L1), and further can reduce the manufacture cost.

A second aspect is an optical system (3) based on the first aspect. In the second aspect, the first propagation direction and the second propagation direction intersect each other in a predetermined plane perpendicular to the thickness direction of the body (40). The second propagation direction in the reproduction region (6) corresponds to the second direction (D2) in the virtual image. The exit diffraction structure (62) divides the plurality of image light rays (L1, L12) propagating in the second propagation direction from the dividing diffraction structure (61) in the second propagation direction to allow them to emerge as a plurality of image light rays (L1, L2) toward the field of view region (8). This aspect can reduce the area of the field of view region (8) where no pupil of the image light ray (L1) is located and improve the usage efficiency of the image light ray (L1), and further can reduce the manufacture cost.

A third aspect is an optical system (3) based on the second aspect. In the third aspect, the exit diffraction structure (62) includes a third diffraction structure region (621). The third diffraction structure region (621) is formed at any one of the first surface (40a) and the second surface (40b) and has periodicity in the second propagation direction. This aspect can reduce the area of the field of view region (8) where no pupil of the image light ray (L1) is located and improve the usage efficiency of the image light ray (L1), and further can reduce the manufacture cost.

A fourth aspect is an optical system (3) based on the second or third aspect. In the fourth aspect, the in-coupling region (5) allows the image light ray (L1) to enter the body (40) so that the image light ray (L1) propagates in the first propagation direction inside the body (40). When a wave vector of the in-coupling region (5) is denoted by ka, and a wave vector of the dividing diffraction structure (61) is denoted by kb, the wave vectors ka and kb satisfy a relation of |ka|>|ka+kb|. This aspect can reduce the area of the field of view region (8) where no pupil of the image light ray (L1) is located and improve the usage efficiency of the image light ray (L1), and further can reduce the manufacture cost.

A fifth aspect is an optical system (3) based on any one of the first to fourth aspects. In the fifth aspect, the optical system (3) further includes a projection optical system (7) allowing the image light ray (L1) from the display element (2) to be incident on the in-coupling region (5) of the light guide (4; 4A; 4B). A first dimension in a direction corresponding to the first direction (D1) of an entrance pupil (P) of the projection optical system (7) is smaller than a second dimension in a direction corresponding to the second direction (D2) of the entrance pupil (P) of the projection optical system (7). This aspect can reduce the area of the field of view region (8) where no pupil of the image light ray (L1) is located and improve the usage efficiency of the image light ray (L1), and further can reduce the manufacture cost.

A sixth aspect is an optical system (3) based on the fifth aspect. In the sixth aspect, when the first dimension is denoted by Ra and the second dimension is denoted by Rb, a relation of 0.3<Ra/Rb<0.7 is satisfied. This aspect can reduce the area of the field of view region (8) where no pupil of the image light ray (L1) is located and improve the usage efficiency of the image light ray (L1), and further can reduce the manufacture cost.

A seventh aspect is an optical system (3A) based on the first aspect. In the seventh aspect, the dividing diffraction structure (61A) functions as the exit diffraction structure (62A). The second propagation direction corresponds to a direction from the light guide (4A) toward the field of view region (8). This aspect can reduce the area of the field of view region (8) where no pupil of the image light ray (L1) is located and improve the usage efficiency of the image light ray (L1), and further can reduce the manufacture cost.

An eighth aspect is an optical system (3) based on the first aspect. In the eighth aspect, the dividing diffraction structure (61B) functions as the exit diffraction structure (62B). Each of the first diffraction structure region (611B) and the second diffraction structure region (612B) has periodicity in two or more predetermined directions (A1, A2, A3) so as to divide the image light ray (L1) incident from the in-coupling region (5) in a plurality of branch directions including two or more branch directions respectively parallel to the two or more predetermined directions (A1, A2, A3), allow a plurality of image light rays (L1) to propagate inside the body (40), and allow the plurality of image light rays (L1) propagating in the plurality of branch directions inside the body (40) to emerge from the body (40) toward the field of view region (8). The plurality of branch directions intersect each other in a predetermined plane perpendicular to the thickness direction of the body (40) and include the first propagation direction and the second propagation direction. This aspect can reduce the area of the field of view region (8) where no pupil of the image light ray (L1) is located and improve the usage efficiency of the image light ray (L1), and further can reduce the manufacture cost.

A ninth aspect is an optical system (3) based on any one of the first to eighth aspects. In the ninth aspect, when a thickness of the body (40) is denoted by t, a propagation angle of a first light beam (first auxiliary light beam L21) which is the largest in the propagation angle in the image light ray propagating in the first propagation direction is denoted by θ1, and a radius of an entrance pupil (P22) of the first light beam (first auxiliary light beam L21) in the first propagation direction is denoted by R1, a relation of 1.6<(t×tan θ1)/R1<2.4 is satisfied. This aspect can reduce the area of the field of view region (8) where no pupil of the image light ray (L1) is located and improve the usage efficiency of the image light ray (L1), and further can reduce the manufacture cost.

A tenth aspect is an optical system (3) based on any one of the first to ninth aspects. In the tenth aspect, when a thickness of the body (40) is denoted by t, a propagation angle of the second light beam (second auxiliary light beam L22) which is the smallest in the propagation angle in the image light ray propagating in the first propagation direction is denoted by θ2, a radius of an entrance pupil (P22) of the second light beam (second auxiliary light beam L22) in the first propagation direction is denoted by R2, and a half value of a dimension in the first propagation direction of the in-coupling region (5) is denoted by d0, a relation of 0.7<(2×t×tan θ2)/(R2+d0)<1.5 is satisfied. This aspect can reduce the area of the field of view region (8) where no pupil of the image light ray (L1) is located and improve the usage efficiency of the image light ray (L1), and further can reduce the manufacture cost.

An eleventh aspect is an optical system (3; 3A) including a light guide (4; 4A; 4B) for guiding an image light ray (L1) which is output from a display element (2) and forms an image, to a field of view region (8) of a user as a virtual image. The light guide (4; 4A; 4B) includes: a body (40) having a plate shape and including a first surface (40a) and a second surface (40b) in a thickness direction; an in-coupling region (5) formed at the body (40) and allowing the image light ray (L1) to enter the body (40) so that the image light ray (L1) propagates inside the body (40); and a reproduction region (6; 6A; 6B) formed at the body (40). The reproduction region (6; 6A; 6B) includes a dividing diffraction structure (61; 61A; 61B) dividing the image light ray (L1, L11) propagating in the first propagation direction intersecting the thickness direction of the body (40) into the plurality of image light rays (L1, L12) propagating in the second propagation direction intersecting the first propagation direction, in the first propagation direction and an exit diffraction structure (62; 62A; 62B) allowing the plurality of image light rays (L1, L12) propagating in the second propagation direction to travel toward the field of view region (8). The dividing diffraction structure (61; 61A; 61B) includes a first diffraction structure region (611; 611A; 611B) and a second diffraction structure region (612; 612A; 612B) which are respectively formed at the first surface (40a) and the second surface (40b) to face each other. An entrance pupil (P) of the projection optical system (7) has a first direction (D1) and a second direction (D2) which are perpendicular to each other. A first dimension in the first direction (D1) of the entrance pupil (P) is smaller than a second dimension in the second direction (D2) of the entrance pupil (P). The first propagation direction in the reproduction region (6; 6A; 6B) corresponds to the first direction (D1) in the entrance pupil (P). This aspect can reduce the area of the field of view region (8) where no pupil of the image light ray (L1) is located and improve the usage efficiency of the image light ray (L1), and further can reduce the manufacture cost.

A twelfth aspect is an optical system (3; 3A) including a light guide (4; 4A; 4B) for guiding an image light ray (L1) which is output from a display element (2) and forms an image, to a field of view region (8) of a user as a virtual image. The light guide (4; 4A; 4B) includes: a body (40) having a plate shape and including a first surface (40a) and a second surface (40b) in a thickness direction; an in-coupling region (5) formed at the body (40) and allowing the image light ray (L1) to enter the body (40) so that the image light ray (L1) propagates inside the body (40); and a reproduction region (6; 6A; 6B) formed at the body (40). The reproduction region (6; 6A; 6B) includes a dividing diffraction structure (61; 61A; 61B) dividing the image light ray (L1, L11) propagating in the first propagation direction intersecting the thickness direction of the body (40) into the plurality of image light rays (L1, L12) propagating in the second propagation direction intersecting the first propagation direction, in the first propagation direction and an exit diffraction structure (62; 62A; 62B) allowing the plurality of image light rays (L1, L12) propagating in the second propagation direction to travel toward the field of view region (8). The dividing diffraction structure (61; 61A; 61B) includes a first diffraction structure region (611; 611A; 611B) and a second diffraction structure region (612; 612A; 612B) which are respectively formed at the first surface (40a) and the second surface (40b) to face each other. When a thickness of the body (40) is denoted by t, a propagation angle of the first light beam (first auxiliary light beam L21) which is the largest in the propagation angle in the image light ray propagating in the first propagation direction is denoted by θ1, and a radius of an entrance pupil (P22) of the first light beam (first auxiliary light beam L21) in the first propagation direction is denoted by R1, a relation of 1.6<(t×tan θ1)/R1<2.4 is satisfied. When a propagation angle of a second light beam (second auxiliary light beam L22) which is the smallest in the propagation angle in the image light ray propagating in the first propagation direction is denoted by θ2, a radius of the entrance pupil P22 of the second light beam (second auxiliary light beam L22) in the first propagation direction is denoted by R2, and a half value of a dimension in the first propagation direction of the in-coupling region (5) is denoted by d0, a relation of 0.7<(2×t×tan θ2)/(R2+d0)<1.5 is satisfied. This aspect can reduce the area of the field of view region (8) where no pupil of the image light ray (L1) is located and improve the usage efficiency of the image light ray (L1), and further can reduce the manufacture cost.

A thirteenth aspect is an image display device (1; 1A) including: the optical system (3; 3A) according to any one of the first to twelfth aspects; and the display element (2). This aspect can reduce the area of the field of view region (8) where no pupil of the image light ray (L1) is located and improve the usage efficiency of the image light ray (L1), and further can reduce the manufacture cost.

As above, as examples of techniques in the present disclosure, the embodiments are described. For this purpose, the attached drawings and the description are provided. Therefore, components described in the attached drawings and the description may include not only components necessary for solving problems but also components which are unnecessary for solving problems but useful for exemplifying the above techniques. Note that, such unnecessary components should not be considered as necessary just for the reason why such unnecessary components are described in the attached drawings and the description. Further, the embodiment described above is just prepared for exemplifying the techniques in the present disclosure and thus may be subjected to various modification, replacement, addition, omission, or the like within the scope defined by claims and those equivalent range.

### INDUSTRIAL APPLICABILITY

The present disclosure is applicable to optical systems and image display devices. In more detail, the present disclosure is applicable to an optical system for guiding light from a display element to a field of view region of a user, and an image display device including this optical system.

### REFERENCE SIGNS LIST

1, 1A Image Display Device
2 Display Element
3, 3A Optical System
4, 4A, 4B Light Guide
40 Body
40a First Surface
40b Second Surface
5 In-coupling Region
6, 6A, 6B Reproduction Region
61, 61A, 61B Dividing Diffraction Structure
611, 611A, 611B First Diffraction Structure
612, 612A, 612B Second Diffraction Structure
62, 62A, 62B Exit Diffraction Structure
621 Third Diffraction Structure
7 Projection Optical System
8 Field of View Region
L1, L11, L12, L2, L21, L22 Image Light Ray
P, P21, P22 Entrance Pupil
D1 First Direction
D2 Second Direction

1. An optical system comprising: a light guide for guiding an image light ray which is output from a display element and forms an image, to a field of view region of a user as a virtual image,
the light guide including:
a body having a plate shape and including a first surface and a second surface in a thickness direction;
an in-coupling region formed at the body and allowing the image light ray to enter the body so that the image light ray propagates inside the body; and
a reproduction region formed at the body and including
a dividing diffraction structure dividing an image light ray propagating in a first propagation direction intersecting the thickness direction of the body into a plurality of image light rays propagating in a second propagation direction intersecting the first propagation direction, in the first propagation direction and
an exit diffraction structure allowing the plurality of image light rays propagating in the second propagation direction to travel toward the field of view region,
the dividing diffraction structure including a first diffraction structure region and a second diffraction structure region which are formed respectively at the first surface and the second surface to face each other,
the exit diffraction structure including a third diffraction structure region formed at either one of the first surface or the second surface,
the virtual image having a first direction and a second direction which are perpendicular to each other,
when a first field of view angle in the first direction of the virtual image is denoted by FOV1 and a second field of view angle in the second direction of the virtual image is denoted by FOV2, a relation of FOV2/FOV1<0.5 being satisfied, and
the first propagation direction and the second propagation direction in the reproduction region corresponding to the first direction and the second direction in the virtual image, respectively.

2. The optical system according to claim 1, wherein:
the first propagation direction and the second propagation direction intersect each other in a predetermined plane perpendicular to the thickness direction of the body;
the second propagation direction in the reproduction region corresponds to the second direction in the virtual image; and
the exit diffraction structure divides the plurality of image light rays propagating in the second propagation direction from the dividing diffraction structure in the second propagation direction to allow them to emerge as a plurality of image light rays toward the field of view region.

3. The optical system according to claim 2, wherein
the third diffraction structure region has periodicity in the second propagation direction.

4. The optical system according to claim 2, wherein:
the in-coupling region allows the image light ray to enter the body so that the image light ray propagates in the first propagation direction inside the body; and
when a wave vector of the in-coupling region is denoted by ka, and a wave vector of the dividing diffraction structure is denoted by kb, the wave vectors ka and kb satisfy a relation of |ka|>|ka+kb|.

5. The optical system according to claim 1, further comprising a projection optical system allowing the image light ray from the display element to be incident on the in-coupling region of the light guide,
a first dimension in a direction corresponding to the first direction of an entrance pupil of the projection optical system is smaller than a second dimension in a direction corresponding to the second direction of the entrance pupil of the projection optical system.

6. The optical system according to claim 5, wherein
when the first dimension is denoted by Ra and the second dimension is denoted by Rb, a relation of 0.3<Ra/Rb<0.7 is satisfied.

7. The optical system according to claim 1, wherein
the dividing diffraction structure functions as the exit diffraction structure; and
the second propagation direction corresponds to a direction from the light guide toward the field of view region.

8. The optical system according to claim 1, wherein:
the dividing diffraction structure functions as the exit diffraction structure;
each of the first diffraction structure region and the second diffraction structure region has periodicity in two or more predetermined directions so as to divide the image light ray incident from the in-coupling region in a plurality of branch directions including two or more branch directions respectively parallel to the two or more predetermined directions, allow a plurality of image light rays to propagate inside the body, and allow the plurality of image light rays propagating in the plurality of branch directions inside the body to emerge from the body toward the field of view region; and
the plurality of branch directions intersect each other in a predetermined plane perpendicular to the thickness direction of the body and include the first propagation direction and the second propagation direction.

9. An optical system comprising:
a projection optical system for projecting an image light ray which is output from a display element and forms an image; and
a light guide for guiding the image light ray projected by the projection optical system to a field of view region of a user as a virtual image,
the light guide including:
a body having a plate shape and including a first surface and a second surface in a thickness direction;
an in-coupling region formed at the body and allowing the image light ray to enter the body so that the image light ray propagates inside the body; and
a reproduction region formed at the body and including
a dividing diffraction structure dividing an image light ray propagating in a first propagation direction intersecting the thickness direction of the body into a plurality of image light rays propagating in a second propagation direction intersecting the first propagation direction, in the first propagation direction and
an exit diffraction structure allowing the plurality of image light rays propagating in the second propagation direction to travel toward the field of view region,
the dividing diffraction structure including a first diffraction structure region and a second diffraction structure region which are formed respectively at the first surface and the second surface to face each other,
the exit diffraction structure including a third diffraction structure region formed at either one of the first surface or the second surface,
an entrance pupil of the projection optical system having a first direction and a second direction which are perpendicular to each other,
a first dimension in the first direction of the entrance pupil being smaller than a second dimension in the second direction of the entrance pupil, and
the first propagation direction and the second propagation direction in the reproduction region corresponding to the first direction and the second direction in the entrance pupil, respectively.

10. An image display device comprising:
the optical system according to claim 1; and
the display element.

11. An image display device comprising:
the optical system according to claim 9; and
the display element.
